(19) United States
(12) Patent Application Publication
(10) Pub. No.: US 2022/0405765 A1
(43) Pub. Date: Dec. 22, 2022

(54) KNOW YOUR CUSTOMER (KYC) AND ANTI-MONEY LAUNDERING (AML) VERIFICATION IN A MULTI-DECENTRALIZED PRIVATE BLOCKCHAINS NETWORK

(71) Applicant: OMNIBEK IP HOLDING LLC, Holmdel, NJ (US)

(72) Inventor: Sergey Bekiyants, Holmdel, NJ (US)

(21) Appl. No.: 17/777,603

(22) PCT Filed: Oct. 2, 2020
(86) PCT No.: PCT/US20/54020

§ 371 Date: May 17, 2022

Related U.S. Application Data
(60) Provisional application No. 62/937,100, filed on Nov. 18, 2019.

(51) Int. Cl. G06Q 20/40; G06Q 20/38

(52) U.S. Cl. CPC G06Q 20/40145; G06Q 20/3827; G06Q 20/3829

(57) ABSTRACT

A system for decentralized private blockchains network is provided. In some implementations, the system performs operations comprising receiving, at a client system, data having a sensitivity level, the operations further comprise splitting, at the client system, the data based on the sensitivity level, the splitting comprising splitting the data into data portions. The operations further comprise storing, at a decentralized storage system, the decentralized storage system comprising a plurality of private blockchains, each of the data portions in a separate private blockchain of the plurality of private blockchains. The operations further comprise storing, at a multi-decentralized private blockchains network (MDDV), pointers to locations of the data portions within the decentralized storage system. Related systems, methods, and articles of manufacture are also described.

### CROSS REFERENCE TO RELATED APPLICATIONS

This application claims priority to U.S. Provisional Application No. 62/937,100, filed on Nov. 18, 2019, and entitled KNOW YOUR CUSTOMER (KYC) AND ANTI-MONEY LAUNDERING (AML) VERIFICATION IN A MULTI-DECENTRALIZED PRIVATE BLOCKCHAINS NETWORK, the disclosure of which is incorporated herein by reference.

### TECHNICAL FIELD

The present disclosure relates to the field of blockchain technology and, more specifically, to secure private distributed ledger technology.

### BACKGROUND

A blockchain is a growing list of records or data blocks, which are linked together using cryptography to form a blockchain. Each block may contain a cryptographic hash of the previous block, a timestamp, and transaction data. A blockchain is typically managed by a peer-to-peer computing network in which the nodes in the network collectively adhere to a protocol for inter-node communication and validating new blocks. Once recorded, the data in any given block cannot be altered retroactively without alteration of all subsequent blocks and the consensus of the network majority. As such, a blockchain may be used to produce an immutable record or ledger for the data recorded in each block in the blockchain.

There is a need for highly secure computing infrastructures. There may be problems with organization-organization communication. Traditional API calls do not provide any evidence of execution and returned result. Within a blockchain any transaction, any message between organizations can be validated cryptographically and used as a proof in a dispute. It may be important for regulated entities where one wrong decision may have serious consequences.

### SUMMARY

A multi-decentralized data vault (MDDV) may be created as a secure data storage, retrieval, and confirmation system to support various aspects of digital transactions in the financial technology market, including, for example, the storage and certification of sensitive information (e.g., KYC, identification documents, personal or corporate legal documents, biometric data, and various forms of information storage).

In certain embodiments, multiple forms of biometric data such as voice samples, facial features, eye maps, fingerprints, dynamic facial movement, and DNA fractions may be stored in the MDDV. An individual's biometric data, for example, may be uploaded to the MDDV network, split into redundant fragments, and pointers or references to these fragments may be stored in separate parts of the multi-layered blockchains network along with operations (create, read, update, delete). A confirmation (e.g., a “notary function”) may be generated by the system when certain data is present or stored on the multilayer blockchain. When requested, the data comprising the confirmation may be returned in a sequence according to the provisions of a smart contract. The data may be reconstructed for further processing. In this fashion, the original biometric data elements need not be reconstructed in the system, and instead the confirmation of their presence would be used to ensure the security of the blockchain system.

In some aspects, a method, computer program product and system are provided. In an implementation, a MDDV system is provided. The system can include a client computer system, the client computer system comprising a data splitter configured to split, based on a sensitivity level of data, data received at the client computer system into smaller data portions. The system may further include a multi-decentralized data vault (MDDV) configured to store sensitive data. The system may further include a decentralized storage system comprising a plurality of private blockchains, the decentralized storage system configured to store the data portions in separate locations.

In some variations, the data may include, for example, passport data, license information, or other types of legal or non-legal information. In some variations, the data stored in the decentralized data storage comprises personal data, keys to digital wallets, know your customer data, documents, biometric data, and audio or video files. In some variations, the biometric data may be selected from fingerprints, DNA information for humans or animals, voice data, and dynamic facial movement data, for example.

In certain embodiments, a method of verifying a transaction is provided. The verifying may be utilized in a know your customer (KYC) network and consistent with anti-money laundering policies. The method includes receiving, at a client system, a data batch comprising a plurality of transactions. The method further includes determining, at the client system, one or more parties associated with the plurality of transactions. The method may further include receiving, at the client system, verification information from the one or more parties. The method may further include transmitting, by the client system, the verification information to a verification processor. The method may further include receiving, from the verification processor and at the client system, a verification result, the verification result indicating the one or more parties is authenticated and comprising a timestamp. The method may further include storing the verification result in a decentralized storage system comprising a plurality of private blockchain networks. The decentralized storage system may be configured to split, based on a sensitivity level of the verification information, the verification information received at the client computer system into smaller data portions. The decentralized storage system may further be configured to store pointers to the data portions of the verification result in separate private blockchain network.

In some variations, the MDDV comprises multiple layers of networks. In one embodiment, a first network layer may include pointers to the data portions stored in the storage system, a second network layer may store logs of CREATE, READ, UPDATE, DELETE operations with the data. Storing pointers may include syncing data between multiple network layers within a blockchain, using the first network level to retrieve conditions, validating the transaction, and writing the result of the validation to the decentralized storage system.

In some variations, the first level of a networks may be configured to define conditions to retrieve data and process in the MDDV. In some variations, the first level of a networks configured to define conditions to retrieve data and process in the MDDV. In some variations, the first level of network may share at least one peer with the decentralized storage system. In some variations, the decentralized storage system includes the second level of network

Depending on implementation, the approach and methodology used to build MDDV applications may include performing individual application functionality in a separate independent decentralized private blockchains network. Transactional or sensitive data may be split-up and stored between several DVS, which may be accessible if there is a condition (e.g., “a trigger”) in the first level blockchain.

Based on an identifiable condition or trigger, the split-up data can be reconstituted from multiple blockchain networks. Depending on implementation, different conditions or rules may be utilized or programmed to retrieve data from multiple DVS, such as a specific transaction in a ledger, multi-signature smart contracts requiring (n of m signatures), multiple blockchains network conditions, as well as any user-defined conditions in a smart contract. In certain embodiments, redundant data elements may be stored in the multiple DVS (e.g., online or offline) to provide a more reliable data retention platform by preventing data loss that may be caused by hardware malfunction or loss of connectivity.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 is a block diagram of a data vault storage for managing the storage and retrieval of sensitive data in a distributed data storage environment implemented over a blockchain network, in accordance with one or more embodiments.

FIG. 2A illustrates a block diagram of a multi-signature smart contract in communication with users of a multi-decentralized data vault distributed ledger network configured for storing portions of sensitive data to a data vault cluster, in accordance with one or more embodiments.

FIG. 2B is an example of a use case diagram of a data vault system network, in accordance with some example implementations.

FIG. 3A is a block diagram of a multi-decentralized data vault distributed ledger network, in accordance with one or more embodiments.

FIG. 3B is a block diagram of a data vault service distributed ledger network in accordance with certain aspects of the present disclosure.

FIG. 4 is a diagram of example class logic of a smart contract in a multi-decentralized data vault distributed ledger network, in accordance with some example implementations.

FIG. 5 is a block diagram of a data vault system environment in accordance with certain aspects of the present disclosure.

FIG. 6 is a diagram of the components of the data vault storage in accordance with certain aspects of the present disclosure.

FIG. 7A depicts an example of a client organization in accordance with certain aspects of the present disclosure.

FIG. 7B depicts an example of a multi-decentralized data vault software development kit (MDDV SDK) in accordance with certain aspects of the present disclosure.

FIG. 8A depicts a flowchart of an example process for splitting data in accordance with certain aspects of the present disclosure.

FIG. 8B depicts a flowchart of an example process for splitting data in accordance with certain aspects of the present disclosure.

FIG. 9 depicts a flowchart of an example process for building data in accordance with certain aspects of the present disclosure.

FIG. 10 depicts a flowchart of an example process for building data in accordance with certain aspects of the present disclosure.

FIG. 11 depicts an example diagram of a read file communication exchange in a data vault system in accordance with certain aspects of the present disclosure.

FIG. 12A is a diagram of example class logic of a smart contract file interface in a distributed ledger network, in accordance with some example implementations.

FIG. 12B is a diagram of example class logic of a smart contract device interface in a distributed ledger network, in accordance with some example implementations.

FIG. 13 is a diagram of example class logic of a smart contract role interface in a distributed ledger network, in accordance with some example implementations.

FIG. 14A is an example diagram of a communication exchange for authentication and registration on a network in accordance with certain aspects of the present disclosure.

FIG. 14B is an example diagram of a communication exchange for a create file on a network in accordance with certain aspects of the present disclosure.

FIG. 14C is an example diagram of a communication exchange for a read file on a network in accordance with certain aspects of the present disclosure.

FIG. 15 is a diagram illustrating a method of exchanging information in a MDDV, in accordance with certain aspects.

FIG. 16A is a diagram of example class logic of biometric authentication in a know your customer (KYC) distributed ledger network, in accordance with some example implementations.

FIG. 16B is a diagram of a biometric authentication setup communication exchange in a KYC network in accordance with certain aspects of the present disclosure.

FIG. 16C is a diagram of a biometric authentication communication exchange in a KYC network in accordance with certain aspects of the present disclosure.

FIG. 17 is a diagram of create file communication exchange in the data vault service in accordance with certain aspects of the present disclosure.

FIG. 18 is a diagram of a read file communication exchange in a data vault service in accordance with certain aspects of the present disclosure.

FIG. 19 is a diagram of an update file communication exchange in the data vault service in accordance with certain aspects of the present disclosure.

FIG. 20 is a diagram of a delete file communication exchange in the data vault service in accordance with certain aspects of the present disclosure.

FIG. 21 is a use cases diagram of know your customer (KYC) network, in accordance with some example implementations.

FIG. 22 is a diagram of know your customer (KYC) network environment, in accordance with some example implementations.

FIG. 23 is a diagram of components of an example know your customer (KYC) network, in accordance with some example implementations.

FIG. 24 is a diagram of an organizational structure of an example know your customer (KYC) network, in accordance with some example implementations.

FIG. 25A is a diagram of example communication connections of an email verification service, in accordance with some example implementations.

FIG. 25B is a diagram of example communication connections of a phone verification service, in accordance with some example implementations.

FIG. 25C is a diagram of example communication connections of a document verification service, in accordance with some example implementations.

FIG. 26A is a diagram of example smart contract class logic for phone verification in a distributed ledger network, in accordance with some example implementations.

FIG. 26B is a diagram of example smart contract class logic for email verification in a distributed ledger network, in accordance with some example implementations.

FIG. 26C is a diagram of example smart contract class logic for document verification in a distributed ledger network, in accordance with some example implementations.

FIG. 26D is a diagram of example smart contract class logic for authorization and recovery requests in a distributed ledger network, in accordance with some example implementations.

FIG. 26E is a diagram of example smart contract class logic for address verification in a distributed ledger network, in accordance with some example implementations.

FIG. 27A is a diagram of an example identity creation communication exchange in a network in accordance with certain aspects of the present disclosure.

FIG. 27B is a diagram of email verification communication exchange in a network in accordance with certain aspects of the present disclosure.

FIG. 27C is a diagram of an authorization communication exchange in a network in accordance with certain aspects of the present disclosure.

FIG. 28A is a diagram of a remote control communication exchange in a network in accordance with certain aspects of the present disclosure.

FIG. 28B is a diagram of a recovery communication exchange in a network in accordance with certain aspects of the present disclosure.

FIG. 28C is a diagram of a document verification communication exchange in a network in accordance with certain aspects of the present disclosure.

FIG. 29 is a diagram of an address verification communication exchange in a network in accordance with certain aspects of the present disclosure.

FIG. 30 is a diagram of a phone proof communication exchange in a network in accordance with certain aspects of the present disclosure.

FIG. 31 is a diagram of a challenge verification communication exchange in a network in accordance with certain aspects of the present disclosure.

FIG. 32 is a diagram of an email proof communication exchange in a network in accordance with certain aspects of the present disclosure.

FIG. 33 is a diagram of a document proof communication exchange in a network in accordance with certain aspects of the present disclosure.

FIG. 34 is a diagram illustrating an example method of verifying a transaction.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance to one or more embodiments, the disclosed subject matter may be implemented using one or more public or private blockchain networks. In one implementation, one or more decentralized peer-to-peer networks may be utilized in which one or more participants maintain a replica of a shared ledger of digitally signed transactions. The replicas may be synchronized through a protocol referred to as consensus. Certain guarantees on the immutability of the ledger may be provided, even if some participants in the application of the consensus protocol are malicious.

Depending on implementation, there may be restrictions on the type and number of participants in the network, the execution of the consensus protocols, or the manner in which the shared ledger is maintained. For example, in an embodiment in which a public blockchain is utilized, participation may be open to anyone. In contrast, in a private blockchain, the participants may be limited to a number of parties that agree to a defined consensus protocol. Advantageously, a private blockchain may be configured to be faster, more secure, and better suited for enterprise use than a public counterpart.

Systems and methods disclosed herein may utilize a private multi-layer blockchain, for example, by partitioning transaction information across multiple data vault services (DVS), using a Data Splitter (DS) and a Data Builder (DB), for example. The DS may be used to split data and distribute the corresponding data bytes (e.g., along with an embedded trigger condition) with a unique hash in multiple DVS. Different trigger conditions combined with a smart contract may be configured to retrieve data from the multiple DVS using a DB, as provided in further detail herein.

Because storing sensitive or personal information in a centralized third-party repository may create significant risks of loss or breach, in accordance with example embodiments, one or more private keys (e.g., secret passphrases, strings of random characters, or grouping of random words) may be utilized to limit access to sensitive or personal information

KYC network also provides the feature for Strong Customer Authentication (SCA) when a user should additionally verify his or her identity using push notification, SMS or email code, biometric authentication or other methods to perform money transfer or any other secure operation.

The biometrics may be based on a user's personal information (e.g., fingerprint, facial features, DNA, voice, etc.) that can verify the user's identity using a KYC network that is based on a multi-decentralized data vault (MDDV). This verification and authentication may be the entry point for other services provided by the KYC network. The personal data may be stored in a secure MDDV to protect the personal data from loss or misuse. After personal data is verified, the KYC network can validate the user's identity to one or more services or platforms without disclosing any of the user's personal data to these services or platforms. Accordingly, once a user's identity is verified by the KYC network, the user may have access to a variety of services.

The KYC network may provide identity verification as a service for business. KYC network may assist the business to onboard customers with full regulatory compliance. This KYC network may verify and authenticate user identity, provides a liveness test by ID document photo and selfie video. Besides, another purpose is automatic authenticity validation of scanned ID document by credentials, including name, age, country of origin, document dimensions and etc. Such data as user age, country of origin, address and more are also verified. The AML, sanctions, politically exposed persons, and counter terrorism financing screening functionality may provide regulatory compliance in real time for regulated financial entities. It may use copies of passport, ID, driving license and utility bills for identity verification. Screening lists check includes an automatic screening of global sanctions lists, instant identifying and blocking of users associated with crime, terrorist financing, and money laundering.

Biometrics-based verification may utilize a group of private blockchain channels in the MDDV. A private blockchain channel may be responsible for a specific type of biometric data (e.g., dynamic facial movement, voice, fingerprint, etc.). A user's biometric template may be encrypted and stored using biometric encryption, untraceable, and cancelable biometrics, which may involve an intentional and systematically repeatable distortion of biometric features and digital key features in order to protect sensitive user-specific data. Additional data (e.g., helper data) may be utilized to securely bind a digital key to a biometric, or extract a key from the biometric, so that neither the key nor the biometric can be retrieved from a stored biometric encryption template. Biometric encryption may display a false rejection rate (FRR) or a false acceptance rate (FAR), which may be improved by the use of multi-factor verification feature of KYC network.

For an end-customer, the KYC network may provide digital certificates management solution on top of a Public Key Infrastructure (PKI) to control digital certificates assigned to the user's account. By storing an identity's personally identifiable information (PII) outside of a certificate and decentralizing responsibility of the KYC verification between independent data processors. Thus, an issue with a centralized certificate authority (CA) (which is a single point of compromising) is solved. All a user's PII may be stored using the MDDV technology which provides secure and GDPR compliant data storage. The user may have full control of his PII and may grant access to KYC data processors using his electronic signature.

The proposed system features may have the following advantages. Every single verification (mobile phone, email, document image, risk screening) may be processed with an independent data processor. Data processors may use the blockchain to communicate with each other and with a client through the client organization. Communication may be based on event-driven architecture and the blockchain may act as a message broker with an immutable log of all operations. Every data processor may have its own set crypto materials (private key, certificate). Certificates of the data processor are known by everyone on the network. Each transaction (changing ledger state) done by the data processor may be cryptography signed by the processor's private keys and can be validated by public certificates accessible to participants. Thus, each data processor is responsible for every operation it does.

User's certificate management: revocation and renewal, assigning different certificates to an account may be done by centralized CA. But in this case, all responsibility of these operations, as well as personal data processing and storage, lies on the single entity which can be compromised and perform malicious transactions on behalf of the user or use personal data illegally. In case the user has lost access to his account he can recover it using identity proofs such as document images, one-time password via SMS, email confirmation. The primary verification method, for instance phone number, may be mandatory for account registration. Other verification methods are used for additional account security and for AML policies compliance. Any verification method can be chosen as primary. Phone, email and document proofs are generic functionality for transactions (e.g., SCA for financial transactions) authorization, authentication in the platform and identity proving.

Financial institutions often employ a compliance department to determine whether any customers or transactions involve a sanctioned party as defined in a country's sanction list (e.g., AML list). These financial institutions may benefit from a more automated, accurate, and efficient system to review transactions and determine compliance with any Anti-money laundering and counter terrorist financing regulations. Results from this analysis may beneficially be stored in a blockchain network to provide an added level of security. KYC network modules may provide identity verification as a service for a business. KYC network assists business to onboard customers with full regulatory compliance. This KYC network may verify and may authenticate a user's identity, provide a lifeness test by ID document photo and selfie video. Besides, other purpose is automatic authenticity validation of scanned ID document by credentials, including name, age, country of origin, document dimensions and etc. Such data as user age, country of origin, address and more is also verified. AML service provides regulatory compliance in real time for regulated financial entities. AML/screening lists check includes automatic screening of global sanctions lists, instant identifying and blocking of users associated with crime, terrorist financing and money laundering. This technology may bring a business to regulatory compliance, reduce processing, and increase accuracy of data analysis.

Data may be split into multiple portions by way of a data splitter (DS) 205. The DS 205 may split data into smaller data portions based on one or more factors. One factor may be the sensitivity or importance of the data. For example, highly sensitive data such as personally identifiable information (PII) (e.g., a social security number, a passport number, etc.) may be split into one or more smaller data portions. Splitting data into multiple smaller portions allows the smaller portions of data to be stored in a distributed manner. The more the data is split, the smaller is the chance for data theft or data misappropriation because it would be more difficult for an unscrupulous attacker to piece together the various portions of the data stored in a distributed storage environment.

In some aspects, one or more blockchains in the MDDV may add a unique hash value to the split data portions. The data portions may be stored in the DVS to indicate the location of various portions of the original data split into multiple portions. The multiple data portions may be utilized to reconstruct the original data, when the original data is to be retrieved. In some implementations, the DVS may comprise a database or repository on a client device or server. The DVS may be implemented as an independent unit in a sensitive storage cluster having a first series of peers, unique cryptographic mechanism, and API. A DVS may encapsulate sets of data portions, or pointers to the sets of data portions, without knowledge of data portions stored in others DVSs.

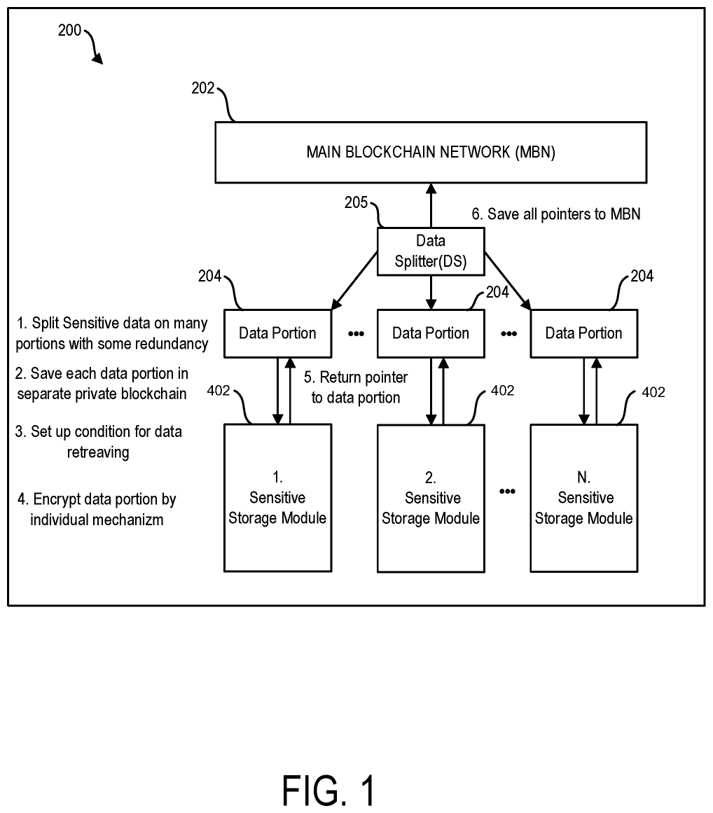

FIG. 1 illustrates a block diagram of at least one multi-decentralized data vault(MDDV) 200, including a cluster of DVSs 402 comprising a plurality of modules. As shown, the MDDV 200 includes a data splitter (DS) 205 configured to split data (e.g., based on a sensitivity level) to be stored and may leverage the split data portions' distribution through multiple DVSs 402 in the MDDV 200. The DS 205 may split data into data bytes (e.g., data portions 204). A blockchain may add unique hash values to the data portions 204, and the data portions 204 may be stored in DVSs 402. The DS 205 may save pointers or references to the different data portions 204 within a main blockchain network (e.g., a MDDV DL network) 202. The DVSs 402 may be constructed on a private blockchain separate or independent from the main blockchain network 202.

The DVS 402 may, for example, be implemented as an independent unit in the MDDV 200 with its own peers, unique cryptographic mechanism, and API. A DVS 402 may encapsulate sets of data portions 204 without knowledge of data portions 204 stored in other DVSs 402. As data portions 204 may be stored into the different DVSs 402, the DVSs 402 may return pointers to the data portions 204 back to the DS 205. The pointers to the data portions 204 may be stored in the MDDV DL network 202. The pointers may include references or links to the locations of the data portions 204 within the respective DVS 402. Additionally, the MDDV DL network 202 may configure conditions for retrieving the data portions 204. In some aspects, the conditions may include requests from a user for personal information or requests from a smart contract to verify a signature or a party to the contract. Because different portions of sensitive data are stored across different DVSs with different encryptions, the MDDV 200 provides increased security for sensitive information.

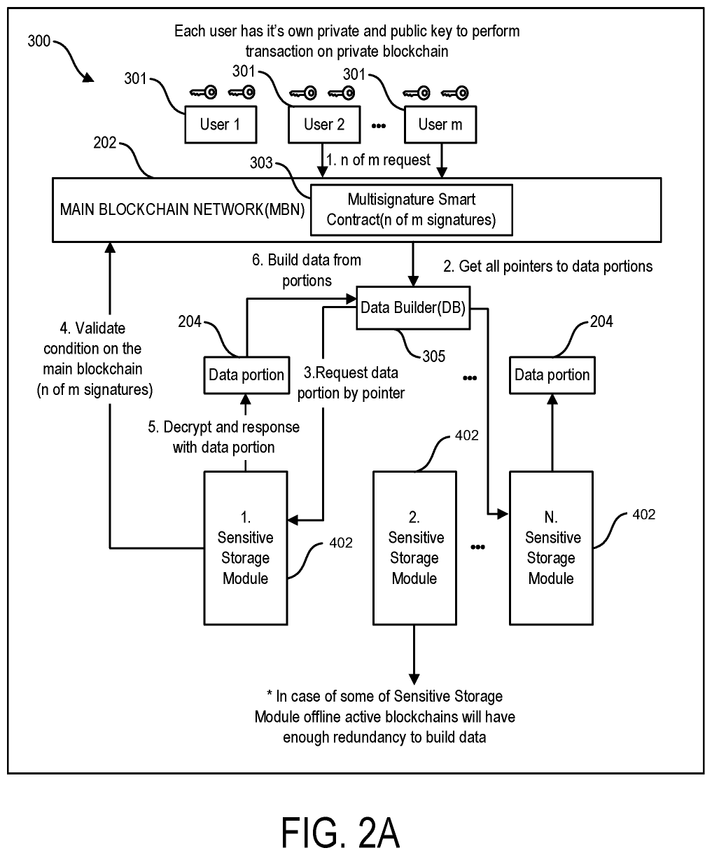

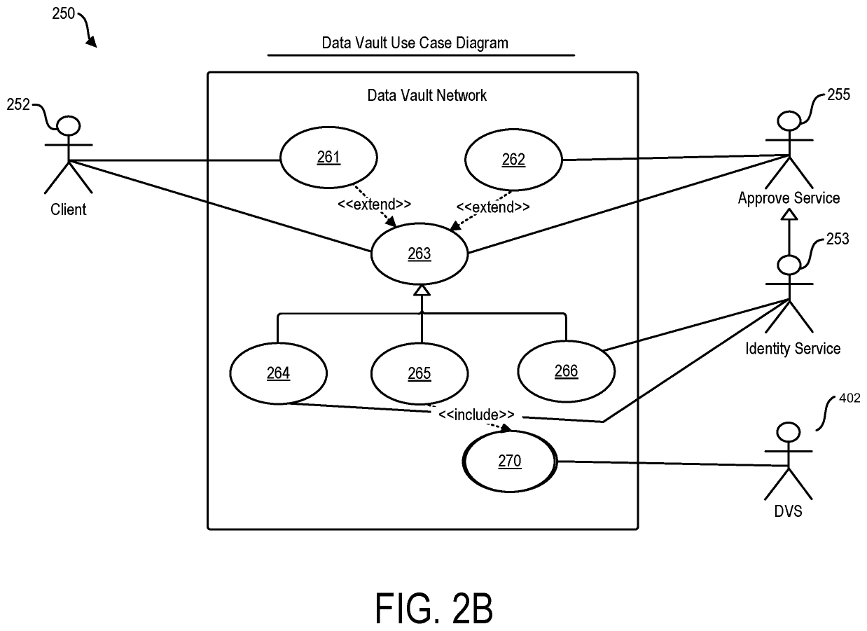

FIG. 2A illustrates a diagram of a multi-signature smart contract 300 in communication with users 301 of the main blockchain network 202, which may be a private blockchain that trusts storing portions of sensitive data to the MDDV 200 containing DVSs 402. The main blockchain network 202 stores pointers to data portions 204. As shown, the main blockchain network 202 includes a multi-signature smart contract 303. In some aspects, conditions to reconstruct or retrieve data previously split by the data splitter 205 and stored and encrypted by the DVSs 402 may be managed by the smart contract 303. Multi-signature requests of the smart contract 303 may be one of the conditions to retrieve data.

In one embodiment, a data builder (DB) 305 may retrieve the pointers to the data portions needed by the smart contract 303 from the main blockchain network 202. In some aspects, the DB 305 may be combined with the DS 205 in one device or module. The DB 305 may transmit a request to DVSs 402 in the MDDV 200 to retrieve the various portions of the requested data stored in a distributed manner in multiple DVSs 402. Such requests may include pointers to the data portions. When the DVS 402 receives the request, the DVS 402 may decrypt the request with the pointer, check a condition in the main blockchain network 202, if the result is positive, retrieve the data portion 204 based on the pointer, and return the data portion 204 to the DB 305. Once the data portions 204 for a requested data are retrieved, DB 305 may combine the data portions 204 to reconstruct the requested data. Introducing data redundancy in the MDDV 200 (with certain logic) may allow for DB 305 to reconstruct the requested data even when one or more of the DVSs 402 may be unavailable, corrupted or otherwise compromised. The DVS 402 may participate in transaction validation within its own blockchain peers and at the main blockchain network 202, and may sync the ledger on both chains.

The embodiments described herein may be applied in a variety of implementations. For example and with reference to FIGS. 1 through 3, a user 301 of the MDDV 200 may be entering sensitive personally identifiable information (PII) at a client system.

FIG. 2B is an example is a use case diagram of a data vault system network 250, in accordance with some example implementations. As shown in FIG. 2B, the network 250 includes a client 252 accessing the network. In some aspects, the client 252 accesses the network 250 via a computing system (e.g., a computer processor, tablet, smart phone, server, or the like). As further shown, the user (e.g., client 252) may register to the network 250. In some implementations, registration may include an identity service 253. The identity service 253 may inherit approve service 255 functionality of approving multi-signature requests. The registration may include the client 252 sending a request 261 to access the network. In response to the request, the approve service 255 may process the request at 262 that is part of a multi-signature operation 263. The approve service 255 may implement a multi-signature or multi-step logic to take place on the platform. In the multi-signature operation, multiple parties may review and perform an approve(sign) operation. Processes on the platform can involve multiple participants (clients 252, approve service 255, identity service 253, or the like) or may involve only one party. The approve service 255 may require several actions before an access request is approved. File access may be granted only if all access steps finished with approval. Another option is to use specifically designed approve service 255, that will implement their own way of checking file access. These services, upon executing their own logic of verification, will either approve or decline file access request by signing the access request. The logic may include manual file access approval by a person, simple access request logging and automatic approval, requesting a multifactor authentication from an identity that wants to read the file, neural-network based solution that analyzes the request, or the like.

The identity service 253 may include a person or software which interacts with the platform to review and approve multi-signature operations 263. The identity service 253 may represent a subsystem responsible for user authentication and containing additional information about a client 252 that identity service 253 can put to the platform to create an additional binding between MDDV and the platform where MDDV is integrated. The identity service 253 may perform CRUD Device 266, a group of operations to create, read, update, delete (CRUD) client devices authorized to access MDDV (e.g., MDDV 200). The client 252 device may be represented by a private key and certificate but, it can be any authentication method. The client 252 may initiate registration (e.g., creation of a device on the platform) with an identity service 253 or multiple identity services 253 to approve registration and complement (e.g., update) the platform with information about the client 252. The identity service 253 may also perform CRUD Role 264, a group of operations to create, read, update, delete (CRUD) roles that can be assigned to the client 252 to get the client permissions to perform certain actions on the platform like identity service 253, approve service 255, or any custom role. The identity service 253 may also perform CRUD File 265, a group of operations to create, read, update, delete (CRUD) files and manage access to the files. The DVS 402 may perform CRUD File data 270, a group of operations to create, read, update, delete (CRUD) file data. In comparison with 263, CRUD File data 270 may encapsulate operations only with file binary data but not with meta information and access schemas.

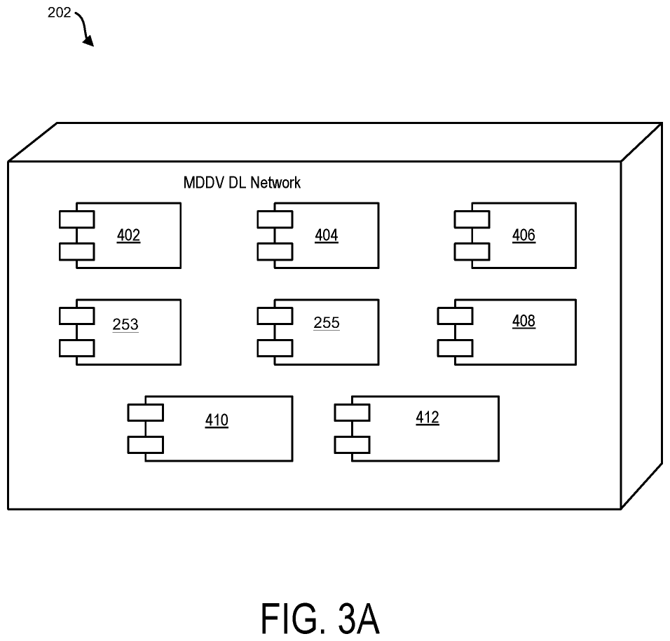

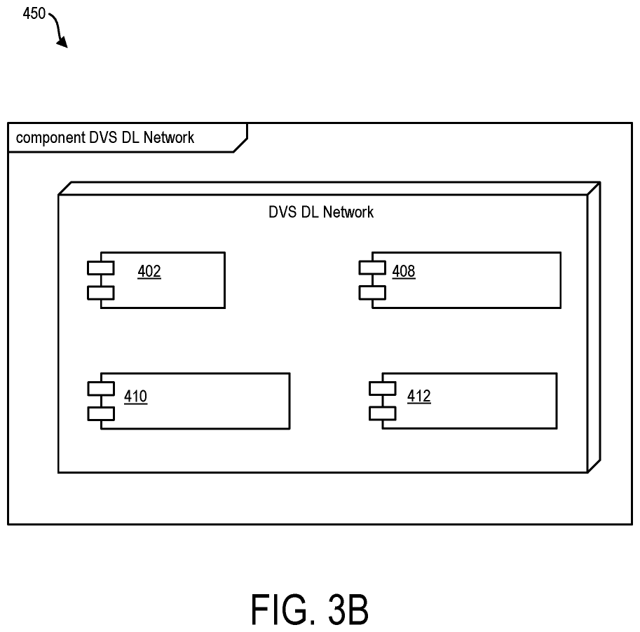

FIG. 3A is a block diagram of a multi-decentralized blockchain data vault (MDDV) network 202, in accordance with one or more embodiments. The MDDV network 202 is an example of a common network for all DVS instances, data processors, monitoring organizations and client organizations. Smart contract logic of a network (e.g., MDDV network 202) may define rules and permissions for all multi-signature operations with files, roles, and devices. A distributed ledger (DL) may keep a log of operations with files, roles, and devices such as create, update, and delete as well as requests and approvals of multi-signature operations. As shown in FIG. 3A, the MDDV DL network 202 includes three instances of data vault services (DVS) 402, 404, and 406. The MDDV DL network 202 further includes an identity service 253, an approve service 255, a data processor 408, a monitoring organization 410, and a client organization 412. In some aspects, each of the DVS 402, 404, and 406 may be configured for storage of an original data chunk and may be configured to provide permission-based access to the original data chunk. Each DVS 402, 404, and 406 may not hold more than 1 chunk of a file. This may be enforced by the client organization 412. Each DVS 402, 404, and 406 may validate the request (e.g., verify the signed request and check access request status in a MDDV DL Network 202 using SC VerifyAccess interface). Optionally, each DVS may log all get/put requests. The DVS DL Network 450 may be used for this purpose. The monitoring organization 410 may perform transaction validation on distributed ledger networks for the benefit of the client organization 412. The monitoring organization 410 may interact with a Smart Contract Create Read Update Delete (CRUD) File interface to perform regulatory functions. The client organization 412 may represent software and hardware infrastructure which may provide access to DL networks to clients. The client organization 412 may also participate in transaction validation on DL networks. The data processor 408 may be configured with permissions to READ, UPDATE or DELETE data provided by a client or another data processor 408. The data processor 408 may also participate in transaction validation on DL networks. The identity service 253, approve service 255, data processor 408, monitoring organization 410, and client organization 412 are represented in FIG. 3A by one instance each, but other implementations can include multiple instances of each or may not have an instance at all. The number of each instance may depend on business logic or other factors.

FIG. 3B is a block diagram of a data vault service (DVS) distributed ledger network 450 in accordance with certain aspects of the present disclosure. As shown, the network 450 includes a DVS 402, a data processor 408, the monitoring organization 410, and the client organization 412. While FIG. 3A depicts the MDDV network 202 which may contain all DVS 402 services, FIG. 3B depicts an individual DVS network 450.

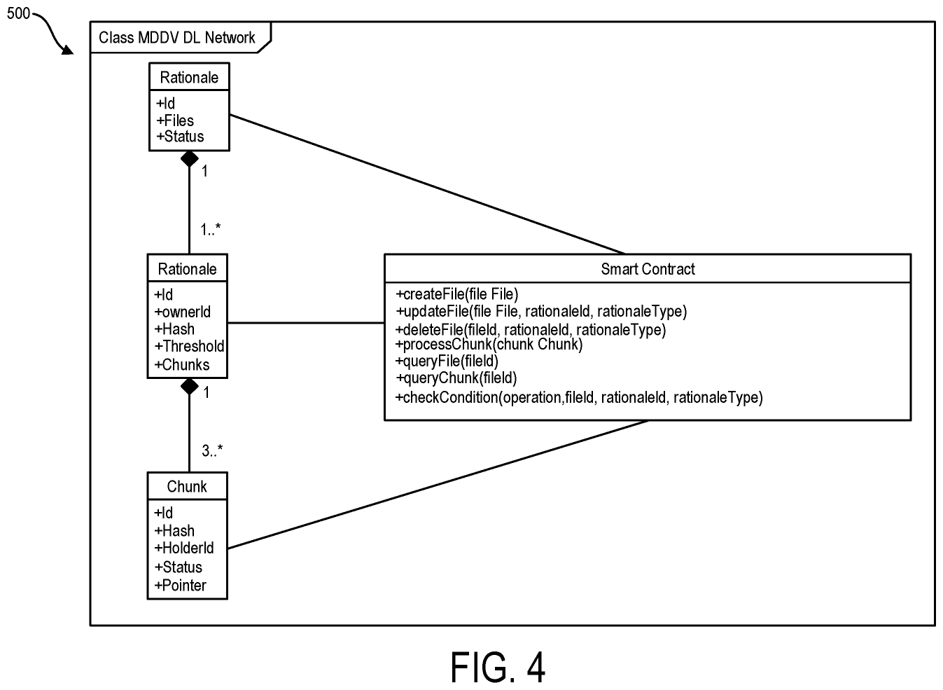

FIG. 4 is a diagram of example class logic 500 of a smart contract in a distributed ledger network, in accordance with some example implementations. As shown, the logic 500 includes class/types of assets: Smart Contract, File, Chunk, and Rationale. Assets are records on a distributed ledger with defined set of attributes, for example information about file. Participants may send transactions to create an asset or change its state. Queries may be read-only operations to retrieve a current state of an asset or a group of assets. Smart Contract may be a software program run on a distributed ledger (DL) network on multiple network instances(nodes) and describes rules and permissions to execute transactions and queries.

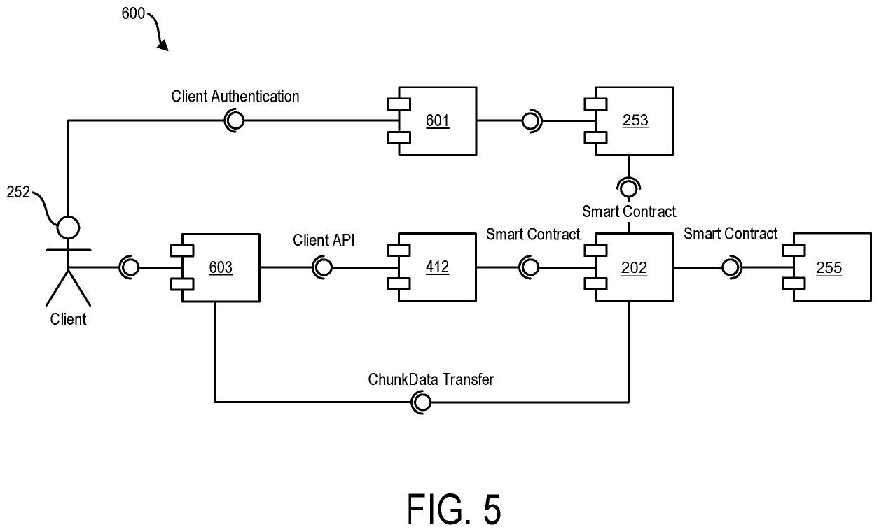

FIG. 5 illustrates a MultiDecentralized Data Vault (MDDV) environment 600. As shown in FIG. 5, the MDDV environment 600 includes a multi-decentralized data vault software development kit (MDDV SDK) 603, a client organization 412, an authentication subsystem 601, the identity service 253, the approve service 255, and a multi-decentralized data vault (MDDV) 202. The client organization 412 may include a client application programming interface (API). As shown, the client organization 412 may represent software and hardware infrastructure, providing access to distributed ledger (DL) networks to clients. End-users (e.g., client 252) may not have direct access to DL infrastructure to execute smart contract (SC) functions. Thus, end-users may communicate with the DL through client organization 412 infrastructure. Client organization 412 may also participate in transaction execution, validation, and signing on DL networks. The MDDV 202 may provide a smart contract interface by means of other participants communicate with it. As shown in FIG. 5, the authentication subsystem 601 may be integrated with any existing IT infrastructure and may be an additional source of information of a client to create a linkage between MDDV 202 and a system where the MDDV 202 has been integrated. Authentication system 601 can also perform MFA(Multifactor Authentication) of the client 252 for MDDV operations. In some aspects, the MDDV SDK 603 may be a client-side software that provides the end-user high-level abstraction over operations with the MDDV 202. The MDDV SDK 603 may be configured to split data on chunks, distribute chunks among different DVSs 402, gather chunks from DVSs 402, and reassembling data.

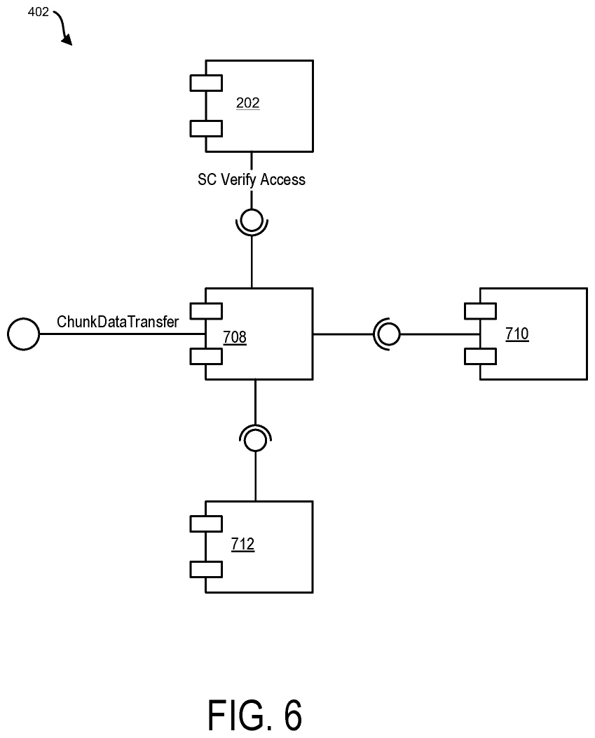

FIG. 6 illustrates an example of a Data Vault service (DVS) 402 in accordance with certain aspects of the present disclosure. The DVS 402 may communicate with the multi-decentralized data vault distributed ledger (MDDV DL) network 202 such as through a SC VerifyAccess interface. The DVS 402 may include a DVS backend 708, a hardware security module (HSM) 710, and a long-term data storage 712. The DVS backend 708 may include non-deterministic logic of a data vault service to receive, encrypt, save chunk data and retrieve, decrypt and send it to a requester on a valid chunk request. Validity on the chunk request may be checked using SC VerifyAccess interface provided by MDDV DL network 202. The HSM 710 may comprise a hardware security module configured to manage digital keys which are used to encrypt and decrypt chunk data. The long-term data storage 712 may include a key-value storage for encrypted chunk data. As shown in FIG. 6, the DVS 402 includes a ChunkDataTransfer, an interface to securely transfer chunk binary data between a client 252 and DVS 402 above DL networks. A result of verification can be ‘success’ or ‘fail’(if something went wrong). The DVS backend 708 may retrieve data from the long-term data storage 712, decrypt it in the hardware security module (HSM) 710 and send chunk data to the requester.

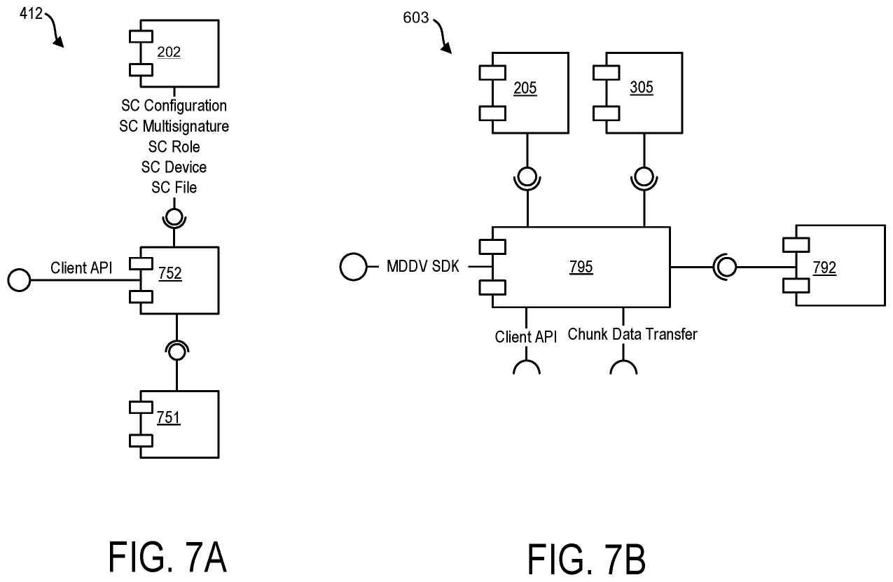

FIG. 7A depicts an example of a client organization 412 in accordance with certain aspects of the present disclosure. The client organization 412 includes the MDDV 202, a client organization backend 752, the long-term data storage 751, and a client application programming interface (API). The client API may be an interface provided to the end user to communicate with the multi-decentralized data vault distributed ledger (MDDV DL) network 202 such as through a SC Configuration, SC Multisignature, SC Role, SC Device, SC File or other smart contract (SC) interfaces and execute transactions and queries defined in a smart contract interface. The client organization 412 includes a client organization backend 752, a long term data storage 751, and a client application programming interface (API). The client API may be an interface provided to the end user to communicate with MDDV DL Network 202 and execute transactions and queries defined in a smart contract interface by means of the client organization. The client API may also include methods for getting MDDV 202 configuration and topology, managing metadata of uploaded files. The client organization backend 752 may include internal logic that handles client API calls and transforms them into smart contract interface calls. The client organization backend 752 may keep actual network topology and monitoring of DVS services to provide it for clients. Also, the client organization backend 752 may use long term data storage 751 to store meta-information about files and performing operations on this data including search. In the example of FIG. 7A, the client organization 412 further includes a smart contract (SC) configuration interface, a part of the smart contract interface to get configuration from MDDV DL Network 202 such as file access schemas, network topology, suggested split schemas, etc.

The MDDV DL network 202 may further include a smart contract (SC) multisignature interface, a part of the smart contract interface to perform operations related to multi-signature logic such as create, read, approve or decline a multi-signature request. The MDDV DL Network 202 further includes a smart contract (SC) role interface, a part of the smart contract interface to perform operations related to role management such as create, read, update, delete a role. The MDDV DL Network 202 further includes a smart contract (SC) device interface, a part of the smart contract interface to perform operations related to device management such as create, read, update, delete a device. The MDDV DL Network 202 further includes a smart contract (SC) file interface, a part of the smart contract interface to perform related to file management such as create, read, update, delete a file. The client organization 412 may communicate with the MDDV DL Network 202 through any or all of the SC configuration, SC multisignature, SC role, SC device, and/or SC file interfaces.

FIG. 7B depicts an example of a multi-decentralized data vault software development kit (MDDV SDK) 603 in accordance with certain aspects of the present disclosure. As shown, the MDDV SDK 603 includes a data splitter 205, a data builder 305, a crypto suite 792, and a shim 795. The data splitter 205 may be configure to receive binary data, perform transformation on this data, and return formed data chunks. The data builder 305 may be configured to receive an array of data chunks, perform validation, transform the data chunks, and return decoded data. If authentication in the MDDV DL network 202 is based on PKI, the crypto suite 792 may include a module that securely generates and stores cryptographic materials (private keys, certificates) necessary for signing transactions in MDDV 202. The crypto suite 792 may securely generate encryption private keys and may encrypt and decrypt data on the data splitter 205 and data builder 305's behalf. The shim 795 may be configured to handle user calls and using other submodules properly form and forward requests to the MDDV (e.g., MDDV 202). The MDDV SDK 603 may include a client API, the client API may be an interface provided to the end user to communicate with MDDV environment 600 and execute transactions and queries defined in the Smart Contract Interface by means of the client organization 412. Also, the MDDV SDK 603 may include methods for getting MDDV 202 configuration and topology, managing metadata of uploaded files. The MDDV SDK 603 may include a ChunkDataTransfer interface, an interface to securely transfer chunk binary data between a client and a DVS above DL networks. Basic realization is represented by two methods of REST API: get chunk by id and put chunk by id. The MDDV SDK 603 may include a MDDV SDK interface, a client-side software that may provide the end-user high-level abstraction over operations with the MDDV 202, The MDDV SDK interface may be configured to split data on chunks, distribute chunks among different DVSs 402, gather chunks from DVSs 402, and reassemble data.

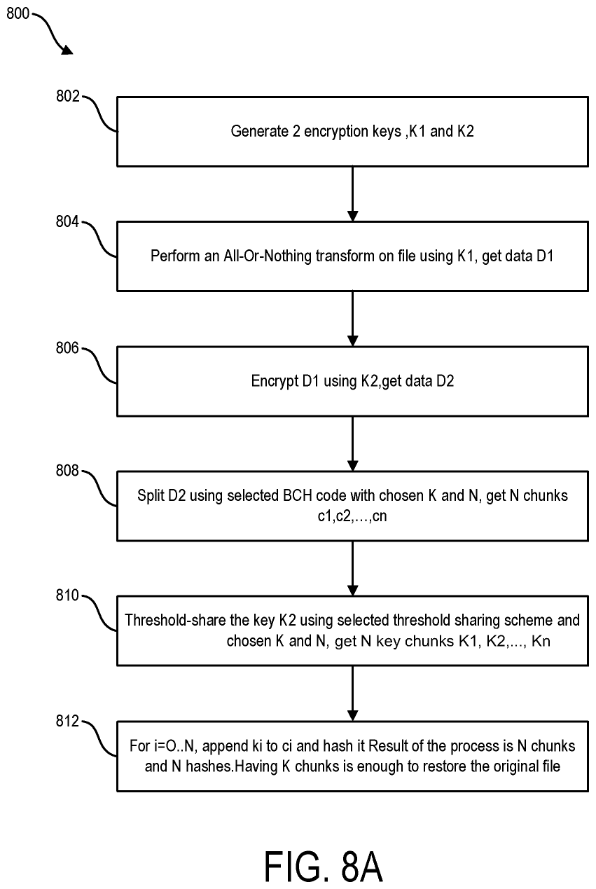

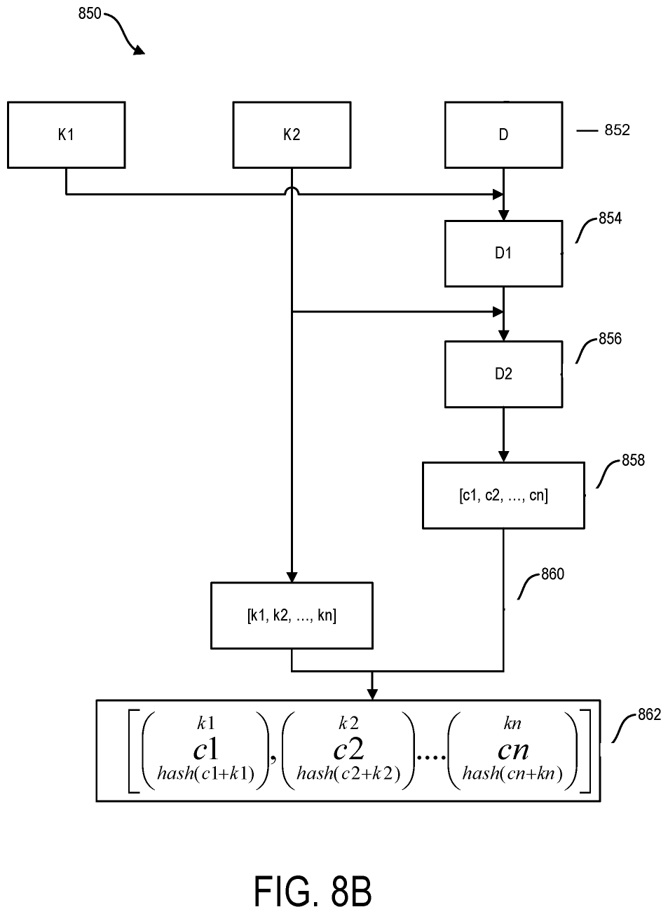

FIG. 8A depicts a flowchart of an example process 800 for splitting data in accordance with certain aspects of the present disclosure. Referring to FIGS. 1-7, the process 800 may be performed by a computing apparatus such as, for example, the data splitter 205, the DVS 402, 404, 406, a computing apparatus, and/or the like. The process 800 may provide a cryptographic platform for exchanging information.

At operational block 802, the data splitter 205 may generate encryption keys for associated data. For example, the data splitter 205 may generate encryption keys K1 and K2.

At operational block 804, the data splitter 205 may perform an all-or-nothing transformation on a data file using an encryption key. For example, the data splitter 205 may transform the file using encryption key K1 to obtain data D1.

At operational block 806, the data splitter 205 may further encrypt the data from block 804. For example, the data splitter 205 may encrypt D1 using encryption key K2 to obtain data D2.

At operational block 808, the data splitter 205 may split D2 using a selected Bose—Chaudhuri—Hocquenghem (BCH) code with a selected quantity of data chunks N and a selected quantity of data chunks K to obtain N number of data chunks, where K chunks are required to reconstruct data D2. Bose—Chaudhuri—Hocquenghem (BCH) codes are a class of cyclic error-correcting codes. For example, the data splitter 205 may select the BCH code, K, and an N quantity of data chunks to obtain the N number of data chunks c1, c2, cn.

At operational block 810, the data splitter 205 may threshold-share an encryption key K2 using a selected threshold sharing scheme, a selected quantity of data chunks N, and a quantity of data chunks to obtain N data key chunks, where K data key chunks are required to reconstruct encryption key K2. For example, the data splitter 205 may split the encryption key K2 using the selected threshold sharing scheme, selected quantity K, and selected quantity N data chunks to obtain N key chunks k1, k2, . . . , kn.

At operational block 812, the data splitter 205 may, for i=0, . . . , N, append ki to ci and hash the appended data chunks. For example, the result of the hashing of the appended chunks may be N chunks and N hashes. The final data chunk transferred to a DVS 402 may be a combination of ci, ki, hash(ci+ki) for i=0, . . . , N. Obtaining K chunks may be enough to restore the original data file.

FIG. 8B depicts a flowchart of an example process 850 for splitting data in accordance with certain aspects of the present disclosure. The process 850 may be performed by a computing apparatus such as, for example, the data splitter 205, the DVS 402, 404, 406, a computing apparatus, and/or the like. FIG. 8B may provide additional details of the process 800 of FIG. 8A.

At level 852, the data splitter 205 may generate encryption keys, K1 and K2, for associated data, D.

At level 854, the data splitter 205 may perform a transformation on a data file D using a first encryption key (e.g., K1) to obtain data D1.

At level 856, the data splitter 205 may encrypt D1 using a second encryption key K2 to obtain data D2.

At level 858, the data splitter 205 may split D2 using a BCH code with a selected quantity of data chunks N and a selected quantity of data chunks, K, required to reconstruct data D2 to obtain N number of data chunks (e.g., c1, c2, cn).

At level 860, the data splitter 205 may threshold-share the encryption key K2 using a selected threshold sharing scheme and selected quantity N key chunks and selected quantity K of key chunks required to reconstruct K2, to obtain N key chunks k1, k2, . . . , kn.

At level 862, for i=0, . . . , N, the data splitter 205 may append ki to ci and hash the appended data chunk. For example, the result of the hashing of the appended chunks may be N chunks and N hashes. In some aspects, the resulting hash may be represented by hash (c1+k1), hash (c2+k2), . . . hash (cn+kn). The final data chunk transferred to a DVS 402 may be a combination of ci, ki, hash(ci+ki) for i=0, . . . , N. As described herein, when assembling data chunks, obtaining K chunks may be enough to restore the original data file.

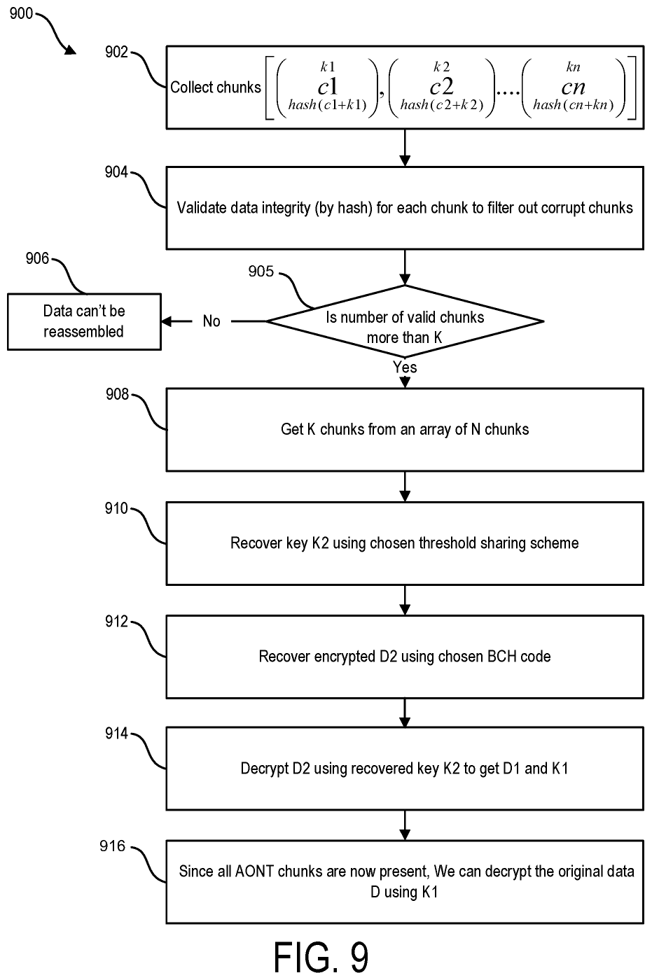

FIG. 9 depicts a flowchart of an example process 900 for building data in accordance with certain aspects of the present disclosure. Referring to FIGS. 1-7, the process 900 may be performed by a computing apparatus such as, for example, the data builder 305, the DVS 402, 404, 406, a computing apparatus, and/or the like.

At operational block 902, the data builder 305 may collect data chunks to reassemble. For example, the data builder 305 may collect data chunks (e.g., c1, c2, cn), key chunks (e.g., k1, k2, kn), and/or hashed data chunks hash (c1+k1), hash (c2+k2), . . . hash (cn+kn).

At operational block 904, the data builder 305 may validate data integrity for each chunk to filter out corrupt chunks. For example, the data builder 305 may validate data integrity by hash.

At operational block 905, the data builder 305 may determine whether a number of valid chunks from the validation of block 904 is equal to or more than K quantity. For example, if the number of valid chunks is below the K threshold, at operational block 906, the data builder 305 may determine that the data cannot be reassembled. If the number of valid chunks satisfies the K threshold, then the process proceeds to block 908.

At operational block 908, the data builder 305 may obtain K data chunks from an array of N chunks. For example, the data builder 305 may obtain K data chunks from an array of N chunks created by the data splitter 205.

At operational block 910, the data builder 305 may recover an encryption key (e.g., K2) using a chosen threshold sharing scheme.

At operational block 912, the data builder 305 may recover encrypted data chunks (e.g., D2) using a chosen BCH code.

At operational block 914, the data builder 305 may decrypt the encrypted data chunks (e.g., D2) using a recovered encryption key (e.g., K2) to obtain data chunks D1 and encryption key K1.

At operational block 916, the data builder 305 may decrypt the encrypted data chunks (e.g., D1) using a recovered encryption key (e.g., K1) to obtain the original data, D.

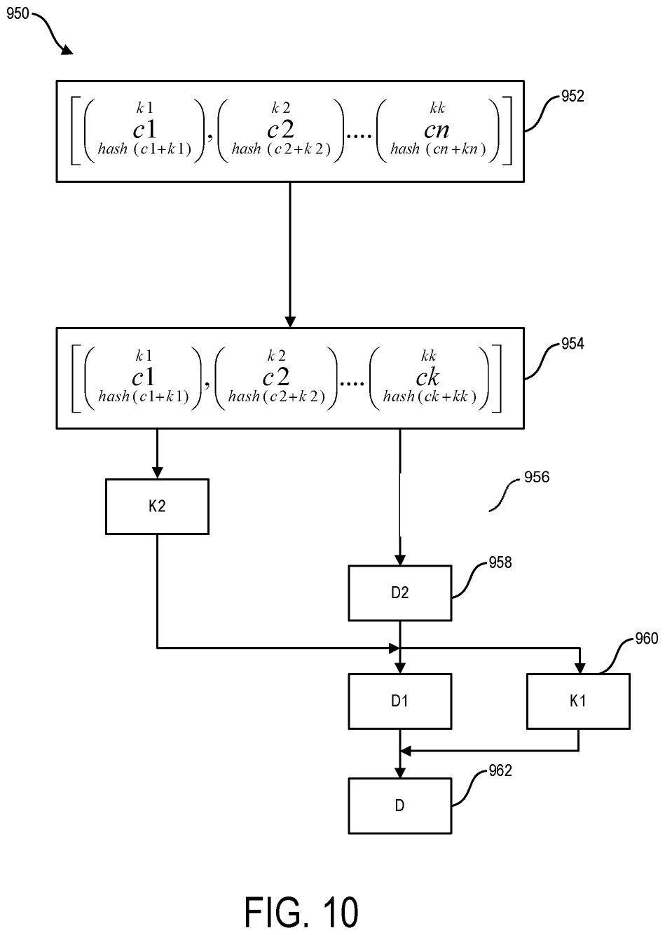

FIG. 10 depicts a flowchart of an example process 950 for building data in accordance with certain aspects of the present disclosure. The process 950 may be performed by a computing apparatus such as, for example, the data builder 305, the DVS 402, 404, 406, a computing apparatus, and/or the like. FIG. 10 may provide additional details of the process 900 of FIG. 9.

At level 952, the data builder 305 may collect chunks (e.g., encryption key chunks k1, . . . kn, data chunks c1, cn, and hash (c1, k1), . . . , hash (cn, kn))

At level 954, the data builder 305 may obtain K chunks from an array of N chunks.

At level 956, the data builder 305 may recover encryption key K2 using a threshold sharing scheme.

At level 958, the data builder 305 may recover encrypted data D2 using a chosen BCH code to facilitate decoding.

At level 960, the data builder 305 may decrypt encrypted data D2 using recovered encryption key K2 to obtain encrypted data D1 and obtain encryption key K1.

At level 962, the data builder 305 may restore the original data file. For example, the data builder 305 may decrypt D1 using encryption key K1 to reconstruct the original file data, D.

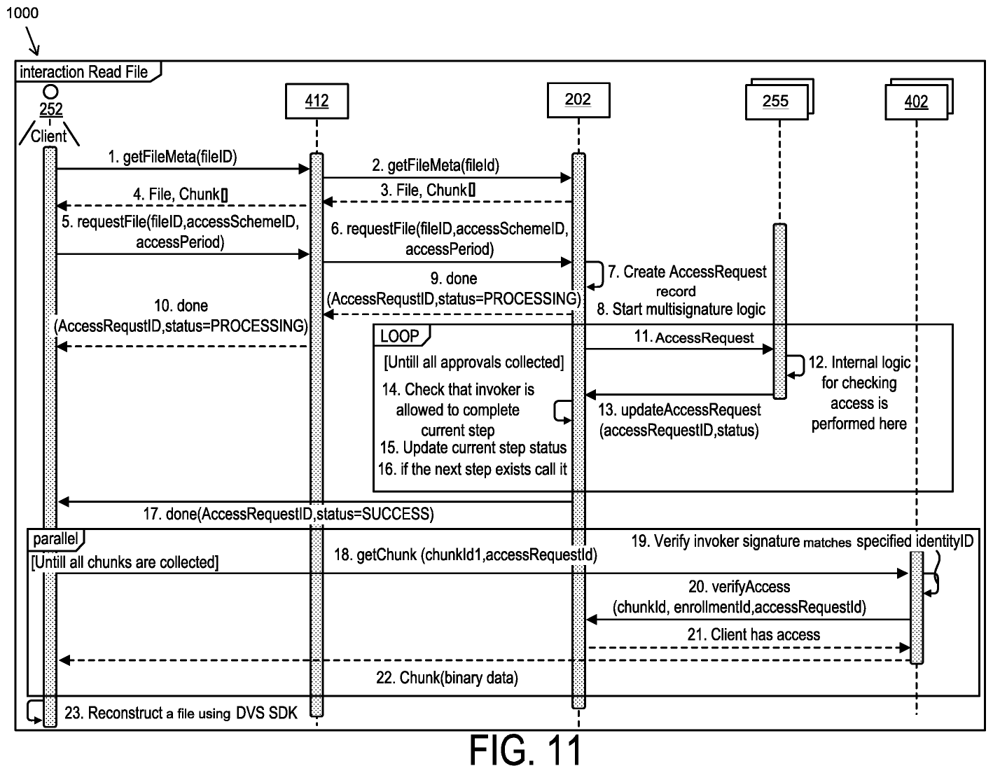

FIG. 11 depicts an example diagram of a read file communication exchange 1000 in a data vault system in accordance with certain aspects of the present disclosure. As shown in FIG. 11, the communication exchange occurs among the client 252, the client organization 412, the MDDV 202, the approve services 255, and a data vault service (DVS) 402.

At steps 1-4, the client 252 may request meta-information of a file from the client organization 412. The client organization 412 may also request the MDDV 202 to get additional data not stored in its local long term data storage (e.g., long term data storage 712).

At steps 5-10, the client 252 may send a request to read a file. The MDDV 202 may create a record in a ledger and may start a multi-signature process. The client organization 412 may return the request to the client 252 in an intermediate status(PROCESSING) that means the client 252 should wait until it'll be resolved.

At steps 11-16, the MDDV DL network 202 may initiate a multi-signature process that notifies the approve services 255. Each approve service 255 may perform some verification logic inside and may make a decision to approve or decline access. In some aspects, the read file communication exchange 1000 may include multiple approve services 255 and steps 11-16 may repeat for each until all approve services 255 make a decision.

At step 17, when all steps are completed, the client 252 may receive a status update for the request(SUCCESS). The client 252 may also call the MDDV 202 to get the actual status of the request.

At steps 18-22, the client 252 may send requests to the DVS 402 to collect chunks of data, until all chunks are collected. Each DVS 402 may validate with the MDDV 202 that the client 252 is authorized to get access to a chunk. If the DVS 402 receives a positive result, it may respond to the client 252 with the data chunk's binary data. In some aspects, the read file communication exchange 1000 may include multiple DVSs 402 and each chunk may be stored in its own DVS 402. A User may request all DVSs 402 (or at least a quantity, K of DVSs to get a “quorum”).

At step 23, when the client 252 gathers a minimum number (e.g., threshold quantity K) of chunks to reassemble a file the client 252 uses data builder 305 to build a file, as described above with respect to FIGS. 9 and 10.

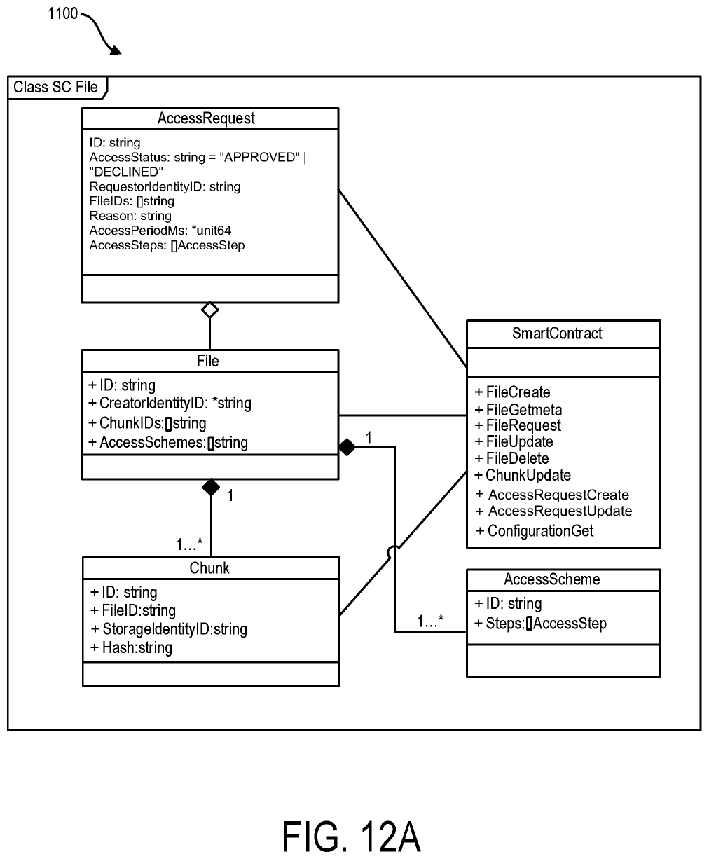

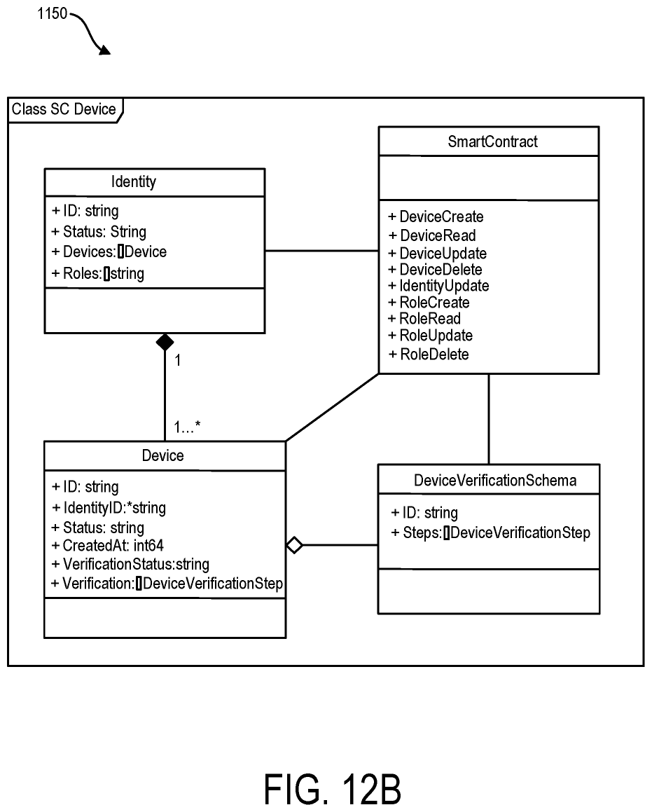

FIG. 12A is a diagram of example class logic of a smart contract file interface 1100 in the MDDV DL Network 202, in accordance with some example implementations. The smart contract file interface 1100 includes classes: AccessRequest, File, Chunk, SmartContract, and AccessScheme. The File class may represent a record in a DL containing information about a file creator, an array of chunks, access schemas to a file, and other meta-information about a file. The Chunk class may represent a record in a DL containing information about a chunk holder (e.g., DVS), hash, status, and a pointer (e.g., a key in a key-value paradigm) in a DVS's long term storage (e.g., long term data storage 712). The AccessRequest class may represent a record in a DL containing information about the execution of a multi-signature(multistep) request for an operation with a file. It contains information about a requestor, requested files, the reason of requesting a file, access time, operation to perform with files. Also, it may include status information about each step in a request logic, such as who approved or declined it, and the global status of a request. The AccessScheme class may represent a multi-signature(multi-step) logic which AccessRequest should follow. AccessScheme may define an array of steps following one by one, each step describes a logic of how or by whom AccessRequest should be processed to perform a requested operation with a file. AccessScheme, for example, may have 3 steps requiring approvals from 3 parties, or 3 steps requiring approvals from 2 specific parties, or parties having a specific role. When the client 252 uploads a file the client may specify one or multiple AccessSchemes for this file. AccessScheme can be a part of a configuration of the SmartContract class (without a possibility to change it in a runtime) to prevent manipulations with it. Once the SmartContract is approved (e.g., cryptographically signed) by all involved parties and instantiated on participants' computers it cannot be modified without collecting approvals from all parties. Thus no one participant can modify access schemas without consensus with all parties.

FIG. 12B is a diagram of example class logic of a smart contract device interface 1150 in the MDDV DL Network 202, in accordance with some example implementations. The smart contract device interface 1150 logic includes classes: Device, Identity, SmartContract, and DeviceVerificationSchema. The Device class may include a record in a DL containing information about a client's device. A device, in turn, represents credentials or physical devices authorized by the system to perform operations with it. The Identity class may include a record in a DL containing information about a client, devices and roles associated with a client 252. An identity record may be created when the first client's device is authorized and created. The DeviceVerificationSchema class may include multi-signature (e.g., multi-step) logic which device creation and update should follow. DeviceVerificationSchema may define an array of steps following one by one, each step describes a logic of how or by whom the device should be processed to perform a requested operation with a device. In an aspect, each step may be processed by an independent identity service (e.g., identity service 253). DeviceVerificationSchema can be a part of a configuration of SmartContract (without a possibility to change it in a runtime) to prevent manipulations with it. Once a SmartContract is approved (e.g., cryptographically signed) by all parties and instantiated on participants' computers it cannot be modified without collecting approvals from all parties. Thus no one participant can modify access schemas without consensus with all parties.

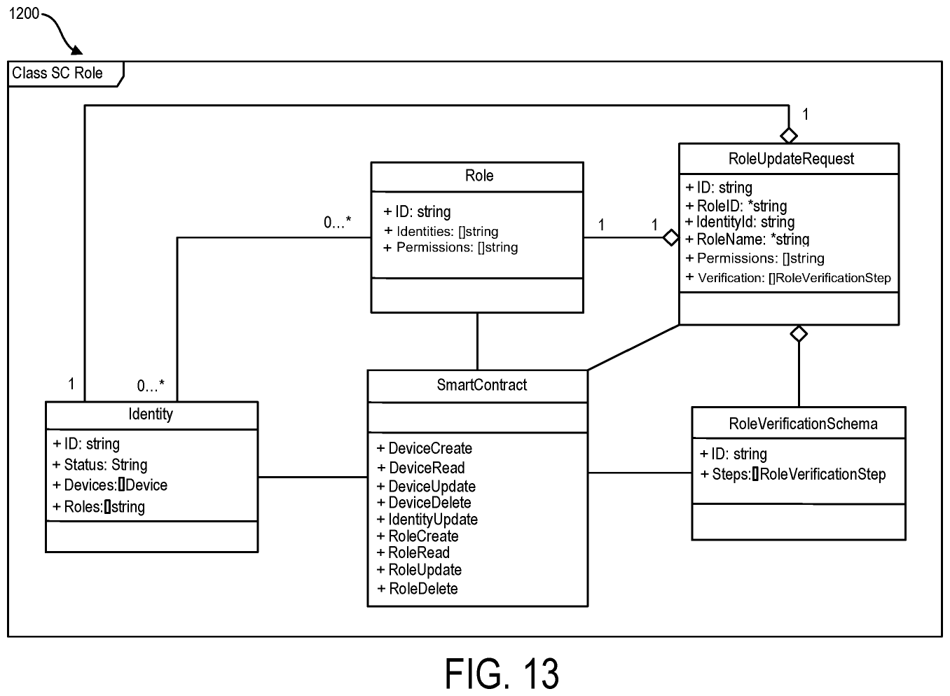

FIG. 13 is a diagram of example class logic of a smart contract role interface 1200 in the MDDV DL Network 202, in accordance with some example implementations. The smart contract role interface 1150 logic includes classes: Role, Identity, RoleUpdateRequest, and RoleVerificationSchema. The identity class may include a record in a DL containing information about a client, devices and roles associated with a client. The Role class may include a record in a DL containing information about a role. The RoleUpdateRequest class may include a record in a DL containing information about the execution of multi-signature (multistep) request for an operation with a role or identity (e.g., to change identity's role). The RoleUpdateRequest may include status information about each step in a request logic, such as who approved or declined it, and the global status of a request. The RoleVerificationSchema may include a multi-signature(multi-step) logic which RoleUpdateRequest should follow. RoleVerificationSchema may define an array of steps following one by one, each step describes a logic of how or by whom RoleUpdateRequest may be processed to perform a requested operation with a role. Each step may be processed by an independent identity service (e.g., identity service 253). RoleVerificationSchema can be a part of a configuration of SmartContract (e.g., without a possibility to change it in a runtime) to prevent manipulations with it. Once a SmartContract is approved (e.g., cryptographically signed) by all parties and instantiated on participants' computers it cannot be modified without collecting approvals from all parties. Thus no one participant can modify access schemas without consensus with all parties.

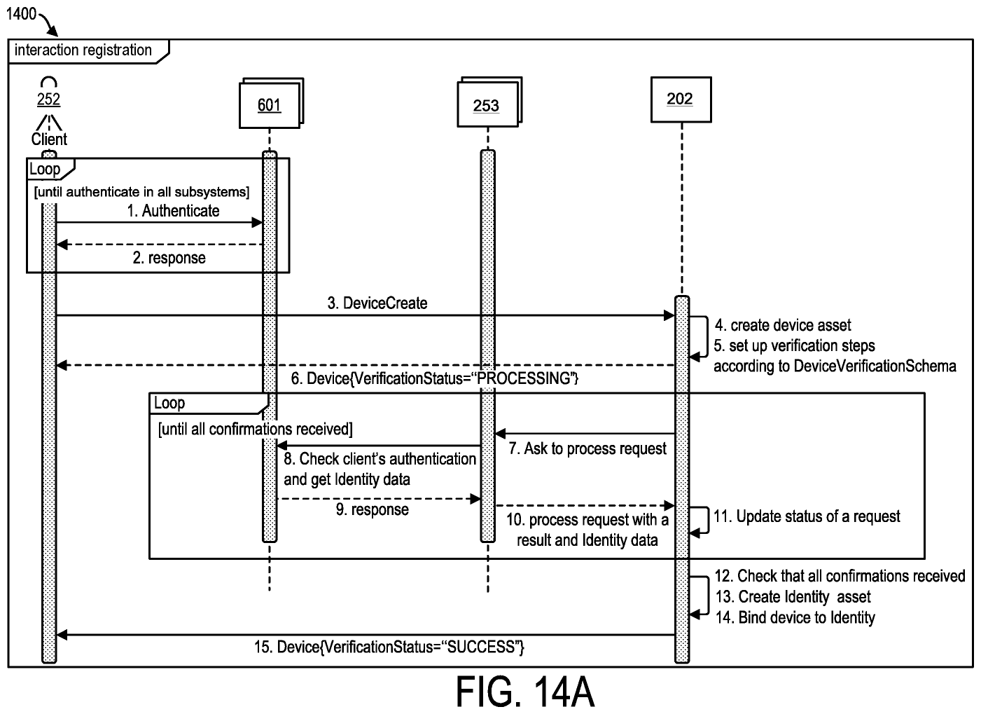

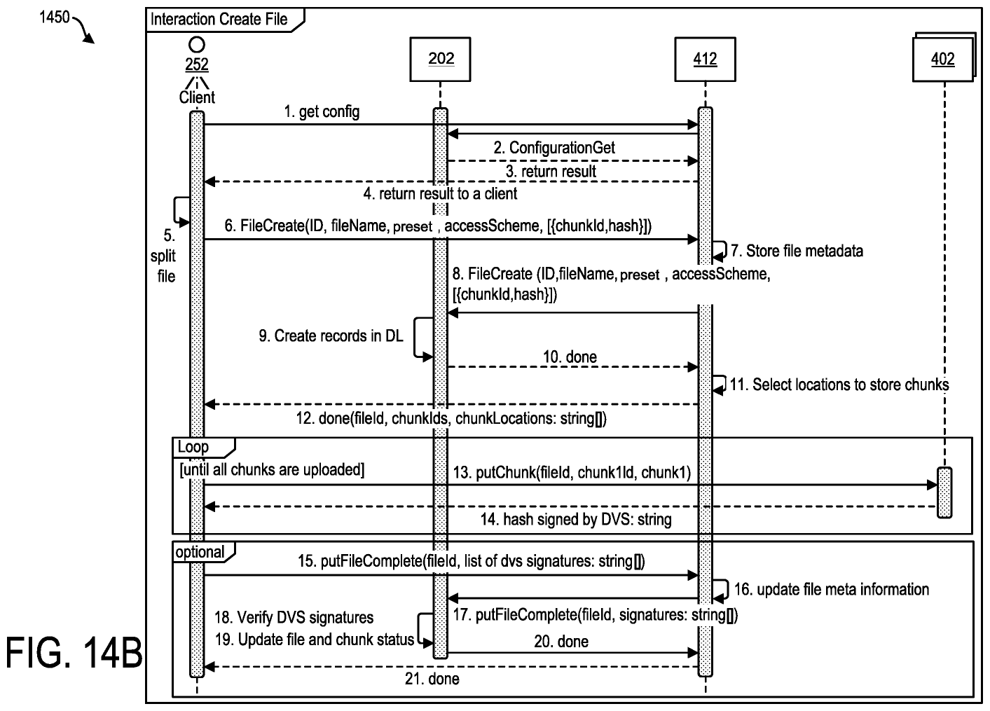

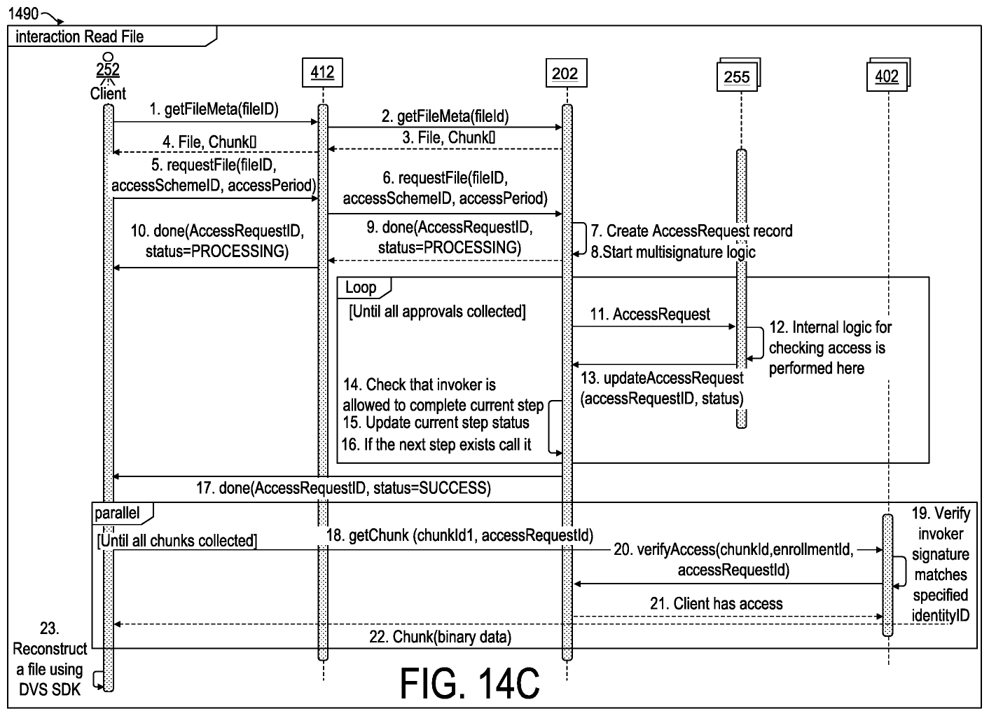

FIG. 14A is an example diagram of a communication exchange 1400 for authentication and registration on a network in accordance with certain aspects of the present disclosure. As shown in FIG. 14A, the communication exchange occurs among the client 252, the authentication subsystem 601, the identity service 253, and the MDDV DL Network 202. Although certain instances or devices are shown, other devices or instances may also participate in the communication exchange 1400.

At steps 1-2, the client 252 may authenticate (e.g., send an authentication request to) with the authentication subsystems 601. Different authentication subsystems 601 may represent different authentication methods.

At step 3, the client 252 may send a request to register a new device to the MDDV DL Network 202.

At steps 4-5, the MDDV DL Network 202 may create a device asset and put a record into the MDDV DL Network 202 with appropriate verification steps in accordance with a Devi ceVerificationSchema.

At step 6, the MDDV DL Network 202 may return a record to the client 252 with a PROCESSING status.

At step 7, the MDDV DL Network 202 may ask all identity services 253 determined from DeviceVerificationSchema to verify and process a request.

At steps 8-9, the identity service 253 may ask the authentication subsystem 601 to check the client 252 authentication and get identity data, additional information about client, etc. (e.g. client's ID to create a linkage between systems).

At step 10, based on a response the identity service 253 may make a decision and processes a request, approve, or decline it.

At step 11, the MDDV DL Network 202 may change or update a status of a request.

At steps 12-14, if all verification steps are passed and verifications received, the MDDV DL network 202 may create an identity record in MDDV DL Network 202 and may bind a device record to it.

At step 15, the client 252 may receive a response from the MDDV 202 with a status SUCCESS.

FIG. 14B is an example diagram of a communication exchange 1450 for a create file on a network in accordance with certain aspects of the present disclosure. As shown in FIG. 14B, the communication exchange 1450 occurs among the client 252, the client organization 412, one or more DVSs 402, and the MDDV DL network 202. Although certain instances or devices are shown, other devices or instances may also participate in the communication exchange 1450.

At steps 1-4, the client 252 may request from the client organization 412 configuration information of a network including network topology, and suggest presets for the data splitter 205 (e.g., the way how data should be split)

At step 5, the client 252 may split data on chunks using data splitter 205

At step 6, the client 252 may send a request to the client organization 412 to create a file record in MDDV DL network 202. The client 252 may send only metadata about a file but not file binary data. The metadata may contain: file ID, file name, access schema, hashes of chunks and their ids.

At step 7, the client organization 412 may save some metadata to a local storage (e.g., a database)

At steps 8-10, the client organization 412 may forward the client's request to the MDDV DL network 202 to create records of a file and chunks in the DL.

At steps 11-12, based on a user location, jurisdiction, availability of DVS services, and other factors, the client organization 412 may choose and send to the client 252 a list of DVS services to store chunks of data.

At steps 13-14, the client 252 may send chunks to the DVSs 402. All chunks of data may be sent to different DVSs. Each DVS may save a chunk to long term data storage (e.g., long term data storage 712) and may return to users (e.g., client 252) a cryptographically signed hash of chunk.

At optional steps 15-21, the client 252 may send an additional request to indicate that all chunks were successfully uploaded to DVS 402. The client 252 can attach collected signatures of chunk hashes. MDDV DL network 202 may validate these signatures and update file and chunks records.

FIG. 14C is an example diagram of a communication exchange 1490 for a read file on a network in accordance with certain aspects of the present disclosure. As shown in FIG. 14C, the communication exchange 1490 occurs among the client 252, the client organization 412, the DVS 402, the approve service 255, and the MDDV DL network 202. Although certain instances or devices are shown, other devices or additional instances may also participate in the communication exchange 1490.

At steps 1-4, the client 252 may request meta-information of a file from the client organization 412. The client organization 412 may also request from the MDDV DL network 202 to get additional data not stored in its local long term data storage (e.g., long term data storage 751).

At steps 5-10, the client 252 may send a request to the client organization 412 to read a file. The client organization 412 may send the request to the MDDV DL network 202. The MDDV DL network 202 may create a record in a ledger and start a multi-signature process. A request may be returned to the client 252 in an intermediate status(PROCESSING) that may mean the client 252 should wait until the request is resolved.

At steps 11-16, the MDDV DL network 202 may initiate a multi-signature process and notify an involved approve services 255. Each approve service 255 may perform some verification logic inside and make a decision to approve or decline access.

At step 17, when all steps are completed, the client 252 may receive a status update for the request(SUCCESS). Or the client 252 can directly call the system (e.g., MDDV 202) to get the actual status of it.

At steps 18-22, the client 252 may send requests to the DVSs 402 to collect chunks of data. Each DVS 402 may validate in the MDDV DL network 202 that the client 252 is authorized to get access to a chunk. If DVS 402 receives a positive result, it may respond to the client 252 with a chunk's binary data.

At step 23, when the client 252 gatherers a minimum number of chunks to reassemble a file, the client 252 may use a data builder (e.g., data builder 305) to build a file, as described above with respect to FIGS. 9 and 10.

In one aspect, the user (e.g., client 252) may be entering a passport number to upload to the MDDV 202. With reference to FIGS. 1 and 2A, upon uploading the passport number, the DS 205 at the client system (e.g., client 252) may split the data into smaller data portions 204 based on a determined sensitivity level of the passport number. In some implementations, the user 301 (e.g., client 252) may select the sensitivity level of the passport number or other information entered into the system. In one implementation, the higher the sensitivity level, the more data portions 204 the DS 205 will split the data into. In some aspects, a large number of data portions 204 may make it harder for a hacker to determine the original data because the hacker will have to overcome the encryptions of each data portion 204 stored in different DVSs 402. Pointers to the location of each data portion 204 may be stored in the main blockchain network (e.g., MDDV DL network) 202.

In one or more embodiments, the MDDV DL network 202 may also configure trigger conditions to retrieve the split data portions 204. For example, if a user loses a private key or the private key is stolen, the user may be requested to enter personal information, enter answers to security questions, or provide biometric data, including voice and dynamic biometrics, for example, in order to recover the private key and access to digital assets. When the trigger conditions have been satisfied, the data builder 305 may retrieve the pointers to the data portions 204 from the main blockchain network (e.g., MDDV DL network) 202. The data builder 305 may then send requests to each DVS 402 in the MDDV 200 that is storing the data portions 204 of the original data (e.g., passport number).

The data splitter 205 may determine the appropriate DVS 402 to contact based on the pointers retrieved from the main blockchain network (e.g., MDDV DL network) 202. Upon receipt of the request from the data builder 305, the DVS 402 may receive the request to retrieve a corresponding data portion 204 and return the data portion 204 to the data builder 305. The data builder 305 may combine the data portions 204 received to reconstruct the original data. For example, the data splitter 205 may split the passport number into chunks and store each chunk of the passport number in a different DVS 402. After responding to the request from the data builder 305, the DVS 402 may transmit the chunk back to the DB 305 in the data builder 305, which may combine the separate chunks of the passport number to determine the original passport number.

Accordingly, the retrieval of sensitive information of the user 301 can be accomplished utilizing the MDDV DL network 200, without having to expose any of the user's personal data to any other blockchain channel. When the user needs to provide proof of requested data, the user may confirm the requested data to the service or transaction requiring it through dynamic biometrics-based verification.

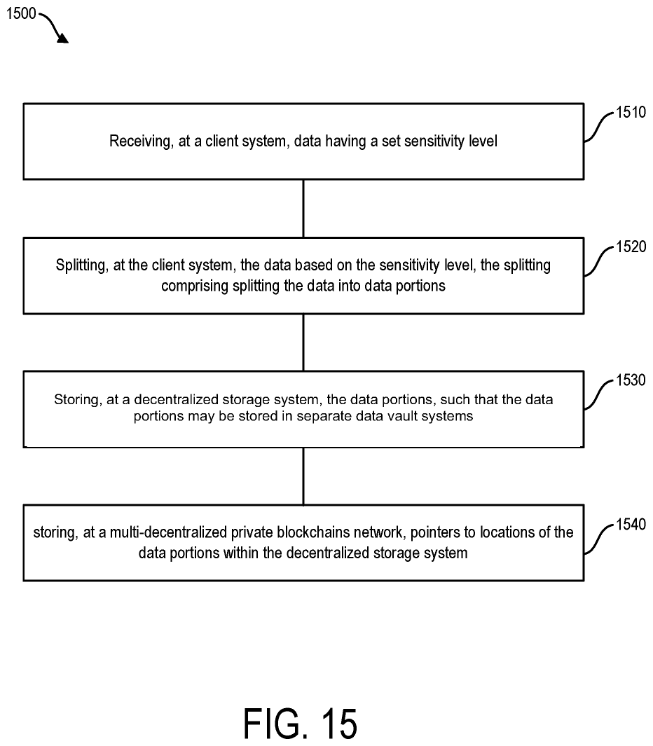

FIG. 15 is a diagram illustrating a method 1500 of exchanging information in a MDDV, in accordance with certain aspects. One or more of the steps described in the method 1500 of FIG. 15 may be performed by a client system 252, the data splitter 205, the DVS 402, a server, or any other similar device. At block 1510, the method includes receiving, at a client system, data having a sensitivity level. At block 1520, the method includes splitting, at the client system, the data based on the sensitivity level, the splitting comprising splitting the data into data portions. For example, the splitting may be performed by the data splitter 205 in accordance with processes 800 and 850 of FIGS. 9A and 9B.

At block 1530, the method includes storing, at a decentralized storage system, the data portions, such that the data portions may be stored in separate DVSs 402. At block 1540, the method includes storing, at a MDDV 202, pointers to locations of the data portions within the decentralized storage system.

A network and an identity management platform may be designed to solve problems and weaknesses of login password authentication. The system may use a public key infrastructure (PKI) as a basic authentication mechanism, but clients' private keys may also be vulnerable. To protect private keys, they may be recorded on special devices like a smart card (chip card, or integrated circuit card) which require special readers to perform cryptographic operations with keys. It may provide strong security but very low usability. The KYC platform described herein may combine the best from different authentication methods: security of PKI and usability of login-password authentication.

With the KYC platform, different authentication methods can be used to protect private keys. Some authentication methods include biometric authentication, one time password (OTP) phone codes, OTP push codes, OTP email codes, RFID chip scanning. Authentication logic can also have multi-signature and multi-step logic which may include multiple persons and multiple authentication methods. This logic can be used to log in third-party applications, authorize financial transactions, blockchain transactions, or any other actions requiring strong customer authentication.

Biometric authentication may include verifying an individual or transaction with biometric data. Biometric authentication may include a full sequence of actions when a client (e.g., client 252) initiates this sequence from one device and uses another device (the same device or multiple devices) that has a biometric module to authorize this action. Biometric verification may include authentication of biometric data by a biometric module by comparing biometric templates (e.g., biometric data, biometric features, or the like). Biometric authentication includes biometric verification.

Biometric authentication supports two realizations that differ by the way of biometric verification: client-side biometric verification assumes that biometric templates (e.g., biometric data, biometric features) never leave the client device, and verification of biometric data is also performed on a client-side. Server-side biometric verification assumes that biometric module extracts biometric template (e.g., biometric data, biometric features) from client's biometrics and transfers this data to the platform to store it and perform a biometric template comparison.

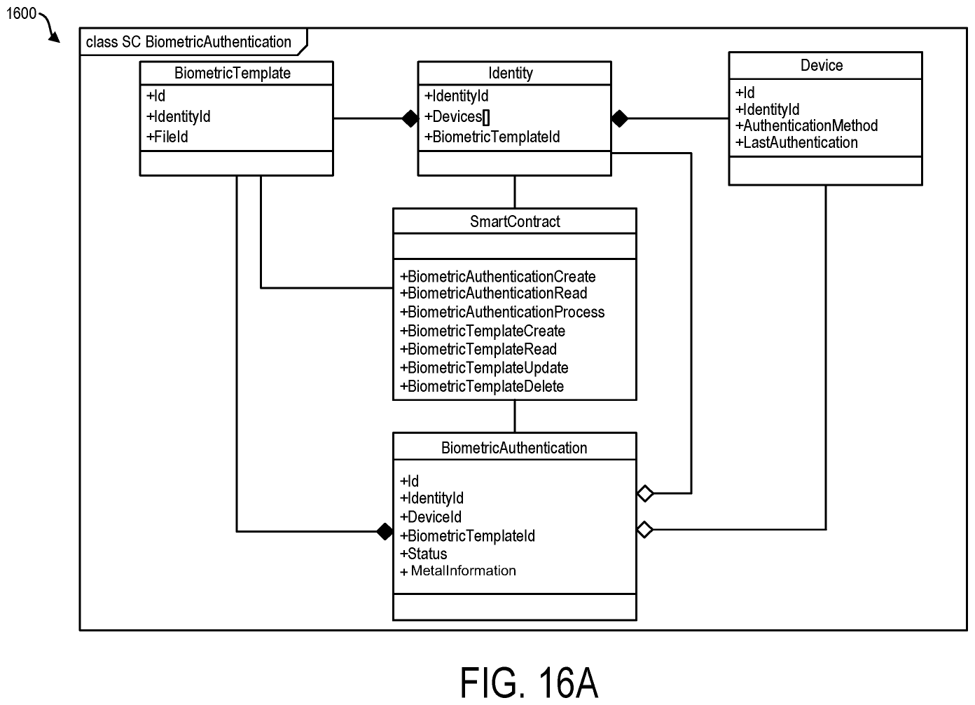

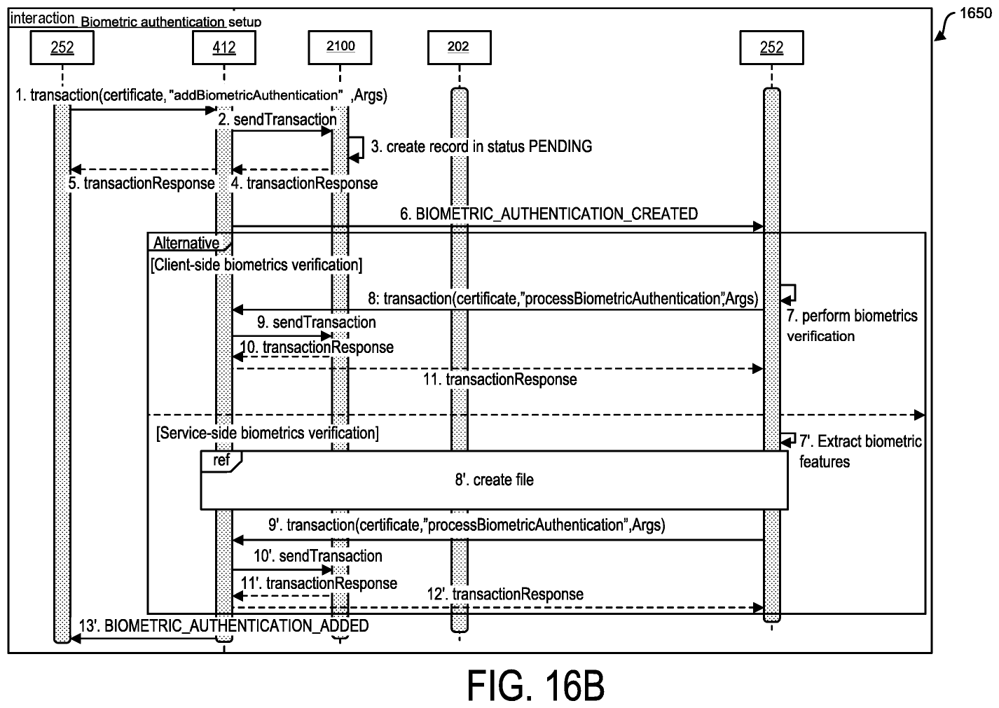

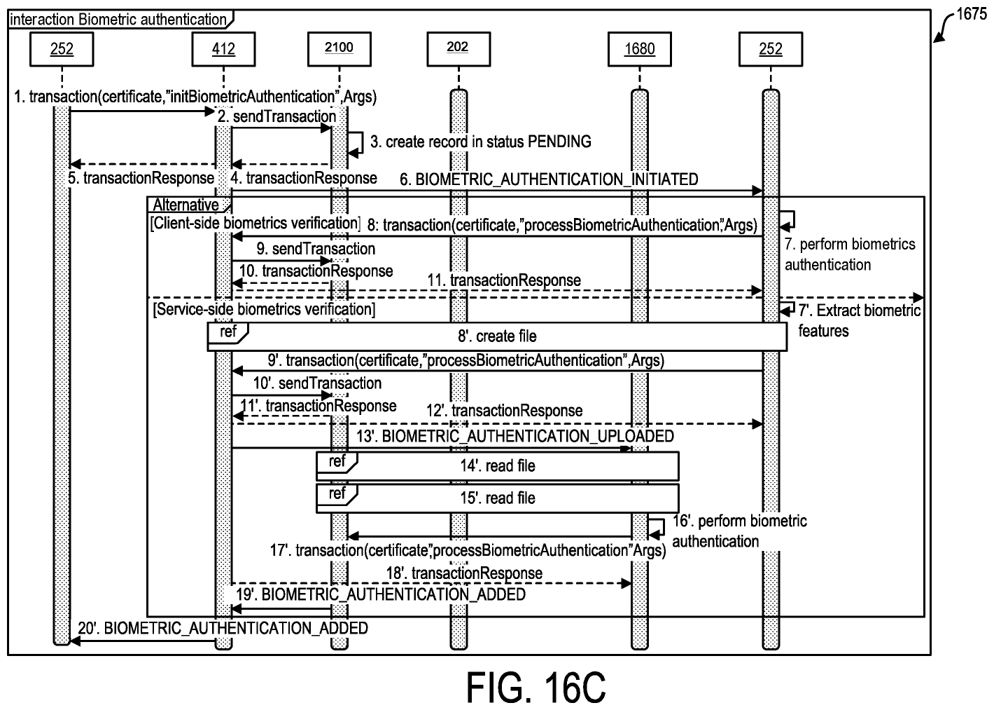

FIG. 16A is a diagram of example class logic 1600 of biometric authentication in a distributed ledger network, in accordance with some example implementations. As shown, the biometric authentication may include a BiometricTemplate class, an Identity class, a Device class, and a BiometricAuthentication class. The Device class may represent a person's device. It may store information about the device and in regards to Biometric Authentication, it may include information about an authentication method, which device is used for Biometric Authentication, information about the last authentication, or the like. The Identity class may represent a real person participating in the KYC network. It may contain a list of connected devices. In regards to biometric authentication, it may include information on the Client's biometric template in the case of server-side biometric verification. The BiometricAuthentication class may represent a record created every time when a client (e.g., client 252) initiates a BiometricAuthentication flow and represents a status of a process. The BiometricAuthentication class may also include information about authentication request like from which device it was initiated, BiometricTemplate that should be authenticated (in case of server-side biometric verification), meta-information that can contain information about a financial transaction, login session or any other operation that requires additional authentication. The BiometricTemplate class may be relevant only for server-side biometric verification. The BiometricTemplate may represent a record containing information about a unique Client's biometric features. In the proposed solution Client's biometric data is stored in the MDDV and a BiometricTemplate record may include a link to a file in the MDDV 202. When client 252 may set up Biometric Authentication the client 252 may provide biometric data and the system may bind created BiometricTemplate with Client's Identity(root template). When Client performs Biometric Authentication it may upload new biometric data which then should be compared with the root template (biometric verification).

FIG. 16B is a diagram of an example biometric authentication setup communication exchange 1650 in a data vault system in accordance with certain aspects of the present disclosure. To set up Biometric Authentication, a client may have authorized device(s) with a biometric module. For more secure authentication, a user may have at least two devices. The first device may initiate an authentication, the second device may perform biometric verification. Meanwhile, all operations may be performed on a single device or by a group of devices with a biometric module.

As shown, the biometric authentication setup communication exchange 1650 includes a first authorized client (e.g., client 252), the client organization 412, a know-your-customer (KYC) network (e.g., KYC network 2100), the MDDV 202, and a second authorized client (e.g., client 252) with a biometric module.

There may be two types of devices with a biometric module: a first device that may extract unique biometric features from the user's face, fingerprint, voice, iris, etc. and then send it to a server where authentication is performed; and a second device that may store and perform biometric features on the device itself. The second device may not send the biometric feature anywhere from a device.

To start using Biometric Authentication a client may set it up first, as shown in FIG. 16B.

At steps 1-5. The first authorized client 252 may initiate a Biometric Authentication setup process by sending a transaction to KYC Network 2100 via the client organization 412. The KYC network 2100 may return a response to the client 252 via the client organization 412.

At step 6, the second authorized client 252 with biometric module may receive an event that a process has been initiated from the client organization 412.

At steps 7-11, if the second authorized client 252 with biometric module is set up to perform biometric verification on a client-side it may perform authentication of a Client's (e.g., client 252) biometrics and send a transaction with a result to KYC Network 2100.

At steps 7′-12′, if the second authorized client 252 with biometric module is set up to perform biometric verification on a server-side, the second authorized client 252 with biometric module may extract biometric features first(7′) then save it to MDDV 202 or another long term data storage (e.g., long term data storage 712). At (8′), the second authorized client 252 sends a transaction with a result to KYC Network 2100(9′-12′).

At step 13, the system (e.g., the client organization 412) notifies the first device (e.g., first authorized client 252) that a process successfully completed.

FIG. 16C is a diagram of a biometric authentication communication exchange 1675 in a data vault system in accordance with certain aspects of the present disclosure. When a client 252 successfully performs a Biometric Authentication setup flow, the client 252 can use Biometric Authentication to log in third-party applications, authorize financial transactions, blockchain transactions or any other action required additional authentication.

As shown, the biometric authentication communication exchange 1675 includes a first authorized client (e.g., client 252), the client organization 412, a KYC network (e.g., KYC network 2100), the MDDV 202, a biometric service 1680, and a second authorized client (e.g., client 252) with a biometric module.

At steps 1-5, the client 252 may initiate Biometric Authentication by sending a transaction to KYC Network 2100 via the client organization 412. The client 252 may pass additional parameters to a transaction in case if the client wants to authenticate some operation outside the platform, like identification of a financial transaction, login details, etc.

At step 6, the system (e.g., client organization 412) may notify the second authorized client 252 with biometric module that the biometric authentication process has been initiated.

At steps 7-11. If the second device(Authorized Client with biometric module) is set up to perform biometric verification on a client-side it performs authentication of Client's biometrics and sends a transaction with a result of biometric verification to the KYC Network 2100.

At steps 7′-19′ If the second authorized client 252 with biometric module is set up to perform biometric verification on a server-side, it may extract biometric features first (7′) then save the biometric features to MDDV 202 or another long term data storage (8′) and may send a transaction with a result to KYC Network 2100 (9′-12′). The biometric service 1680 responsible for server-side biometric verification may receive a notification that biometric features have been uploaded (13′). Biometric service 1680 may read biometric features provided during biometric authentication setup flow (e.g., exchange 1650) and biometric features extracted on step 7′. Biometric service 1680 may perform biometric verification of two files (16′) and may send a transaction with a result to KYC Network 2100 (17′-18′).

At step 20, the system (e.g., client organization 412) may notify the client 252 about the final result of the request.

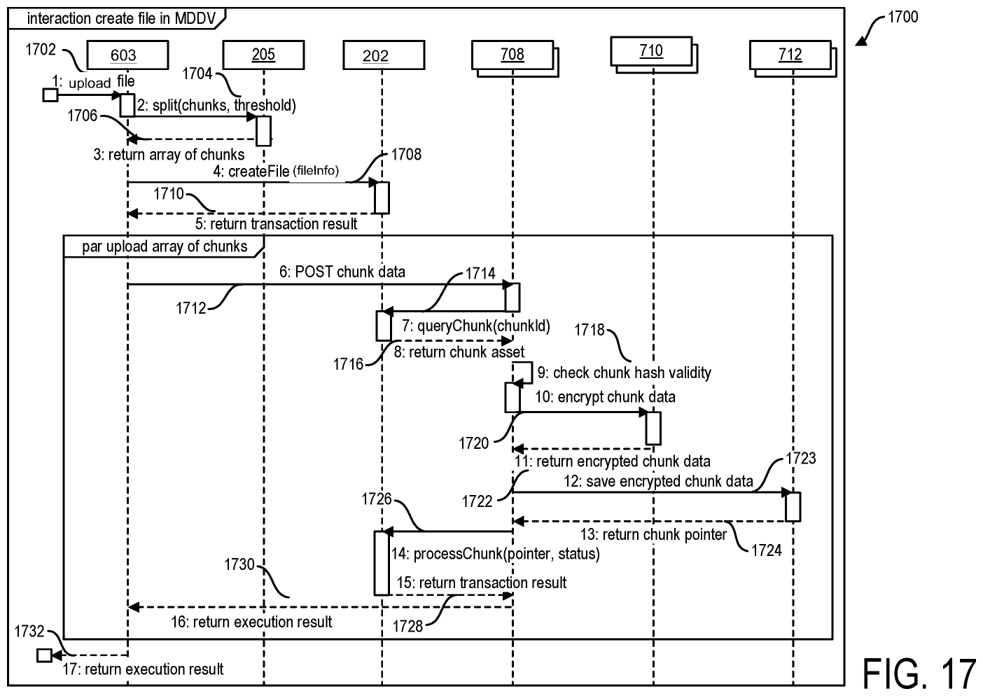

FIG. 17 is a diagram of create file communication exchange 1700 in the MDDV 202 in accordance with certain aspects of the present disclosure. In some implementations, the communication exchange 1700 may provide an alternative to the communication exchange 1450 of FIG. 14B for a create file on a network. In some aspects, the communication exchange 1700 includes executing a create file in a MDDV network. At 1702, a client system (e.g. client 252) uploads a file to the MDDV SDK 603. At 1704, the data splitter 205 splits the original data (e.g. the uploaded file) into data chunks or data portions 204 based on a sensitivity level. At 1706, the data splitter 205 returns an array of data chunks or data portions 204 back to the MDDV SDK 603. At 1708, the MDDV SDK 603 creates a file asset (e.g., SC File) to the MDDV 202. The MDDV DL network 202, at 1710, returns the transaction result to the MDDV SDK 603. At 1712, the MDDV SDK 603 sends chunks data to the different DVS backends 708. The DVS backend 708, at 1714, queries for a chunk (queryChunk) to the MDDV 202. At 1716, the MDDV DL network 202 returns the chunk asset to the DVS backend 708. At 1718, the DVS backend 708 checks the chunk hash validity. At 1720, the DVS backend 708 transmits chunk data to HSM 710 to encrypt it 510. At 1722, the HSM 710 returns the encrypted chunk data to the DVS backend 708. At 1723, the DVS backend 708 saves the encrypted chunk data to the long-term data storage 712. At 1724, the long-term data storage 712 returns a pointer to the chunk data to the DVS backend 708. At 1726, the DVS backend 708 executes a processChunk function (a part of SC File interface) to the MDDV DL network 202 which includes the pointer to the data chunk and a status. At 1728, the MDDV DL network 202 returns a transaction result to the DVS backend 708. At 1730, the DVS backend 708 returns the execution result to the MDDV SDK 603. At 1732, the MDDV SDK 603 returns the execution result to the client system.

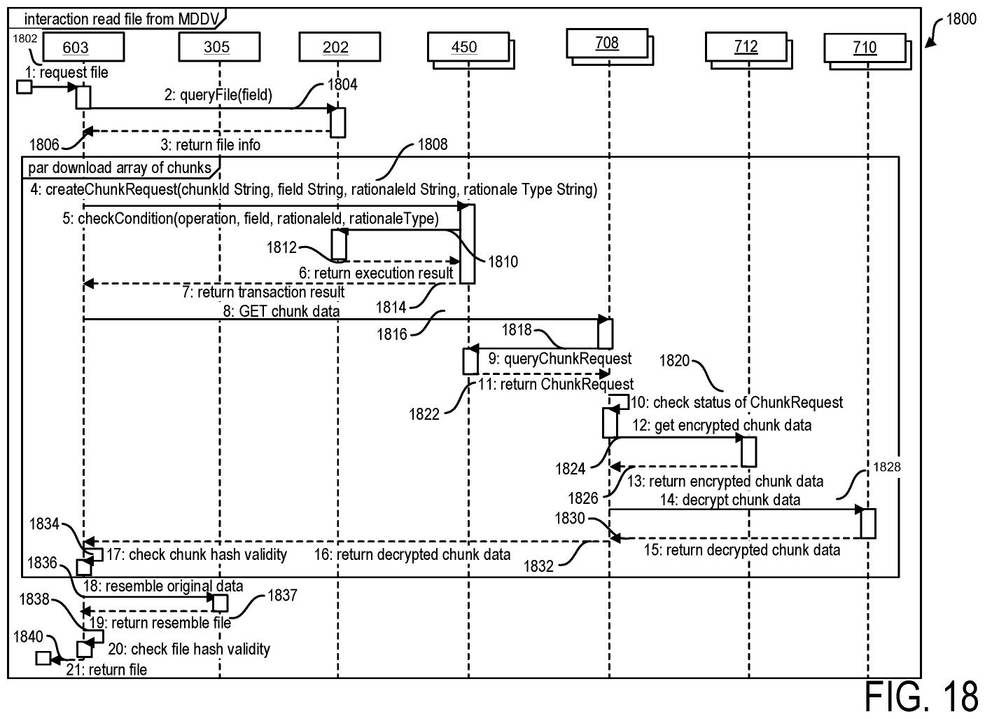

FIG. 18 is a diagram of a read file communication exchange 1800 in a data vault service network in accordance with certain aspects of the present disclosure. In some implementations, the communication exchange 1800 may provide an alternative to the communication exchange 1490 of FIG. 14C for a read file on a network. As shown in FIG. 18, at 1802, a client system (e.g., client 252) may request the file from the MDDV SDK 603. At 1804, the MDDV SDK 603 queries a file from the MDDV DL network 202. At 1806, the MDDV DL network 202 returns the file information back to the MDDV SDK 603. At 1808, the MDDV SDK 603 creates a chunk requests for chunk data from the DVS DL network 450. At 1810, the DVS DL network 450 executes a check condition method to the MDDV DL network 202. At 1812, the MDDV DL network 202 returns execution result for the check condition to the DVS DL network 450. At 1814, the DVS DL network 450 returns a transaction result to the MDDV SDK 603. At 1816, the MDDV SDK 603 transmits a get chunk data request to the DVS backend 708. At 1818, the DVS backend 708 invokes a queryChunkRequest to the DVS DL network 450. At 1820, the DVS backend 708 returns the chunk request to the DVS DL network 450. At 1822, the DVS backend 708 checks the status of the chunk request. At 1824, the DVS backend 708 sends a get encrypted chunk data request to the long-term data storage 712. At 1826, the long-term data storage 712 returns the encrypted chunk data back to the DVS backend 708. At 1828, the DVS backend 708 sends decrypted chunk data to the HSM 510. At 1830, the HSM 510 returns the decrypted chunk data back to the DVS backend 708. At 1832, DVS backend 708 returns the decrypted chunk data to the MDDV SDK 603. At 1834, the MDDV SDK 603 checks the chunk data hash for validity. At 1836, the MDDV SDK 603 sends a request to reassemble the original data to the data builder 305. At 1837, the data builder 305 returns the assembled file to the MDDV SDK 603. At 1838, the MDDV SDK 603 checks the file hash validity of the assembled file. At 1840, the MDDV SDK 603 returns the file back to the client system.

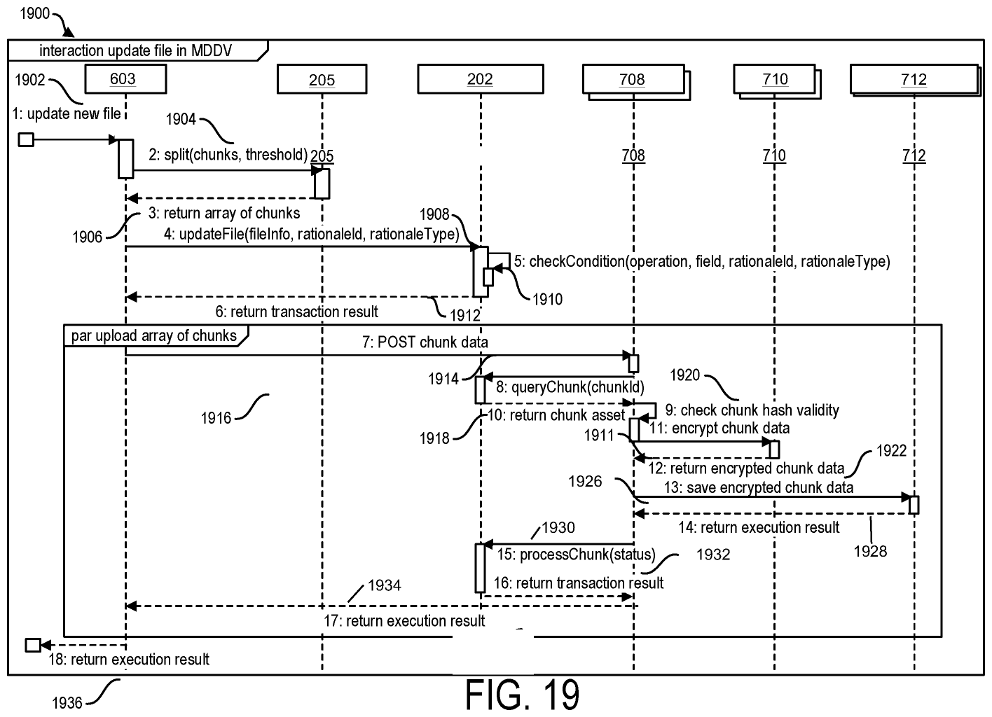

FIG. 19 is a diagram of an update file communication exchange 1900 in the data vault service network in accordance with certain aspects of the present disclosure. As shown in FIG. 19, at 1902, a client system may request a file update from the MDDV SDK 603. At 1904, the MDDV SDK 603 sends the new file to the data splitter 205 to split the data into data chunks, or data portions 204. At 1906, the data splitter 205 returns an array of data chunks or data portions 204 back to the MDDV SDK 603. At 1908, the MDDV SDK 603 sends an update file request to the MDDV DL network 202. At 1910, the MDDV DL network 202 performs a check condition operation on the file. At 1912, the MDDV DL network 202 returns the transaction result back to the MDDV SDK 603. At 1914, the MDDV SDK 603 sends a post chunk data command to the DVS backend 708. At 1918, the DVS backend 708 sends a queryChunk command to the MDDV DL network 202. At 1919, the MDDV DL network 202 returns the chunk asset to the DVS backend 708. At 1920, the DVS backend 708 checks the chunk hash validity. At 1922, the DVS backend 708 sends a command to encrypt chunk data to the HSM 510. At 1924, the HSM 510 returns the encrypted chunk data to the DVS backend 708. At 1926, DVS backend 708 sends a command to save encrypted chunk data by pointer to the Long term data storage 712. At 1928, the long-term data storage 712 returns execution result activity to the DVS backend 708. At 1930, the DVS backend 708 sends a process chunk request to the MDDV DL network 202. At 1932, the MDDV DL network 202 returns the transaction result to the DVS backend 708. At 1934, the DVS backend 708 returns the execution result to the MDDV SDK 603. At 1936, the MDDV SDK 603 returns the execution result to the client system.

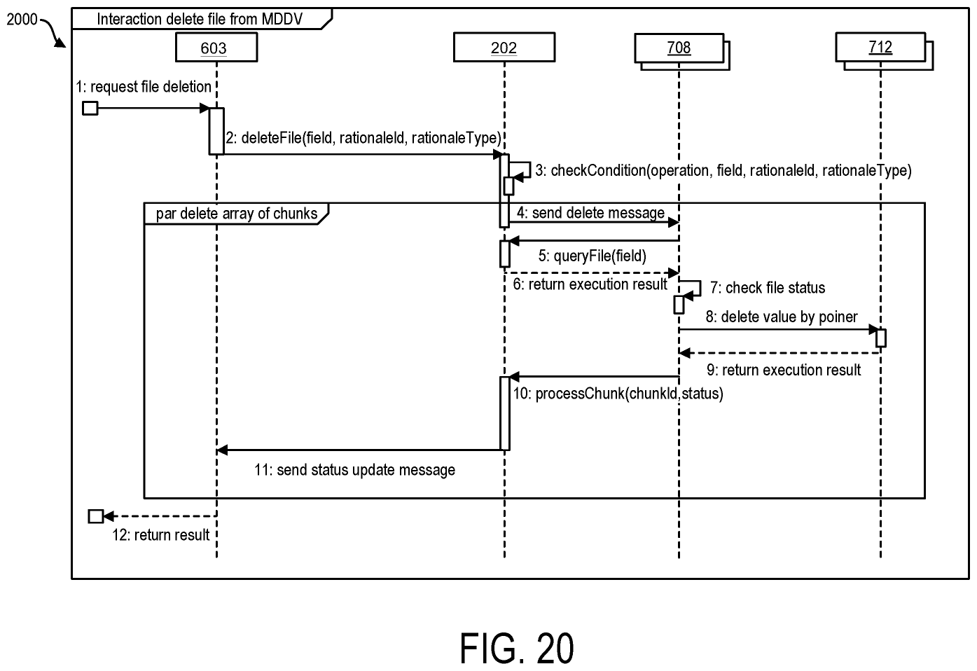

FIG. 20 is a diagram of a delete file communication exchange 2000 in the data vault service network in accordance with certain aspects of the present disclosure. As shown in FIG. 20, communications are exchanged by and among the MDDV SDK 603, the MDDV DL network 202, the DVS backend 708, and the long-term data storage 712 to delete a file from the multi-decentralized data vault system.

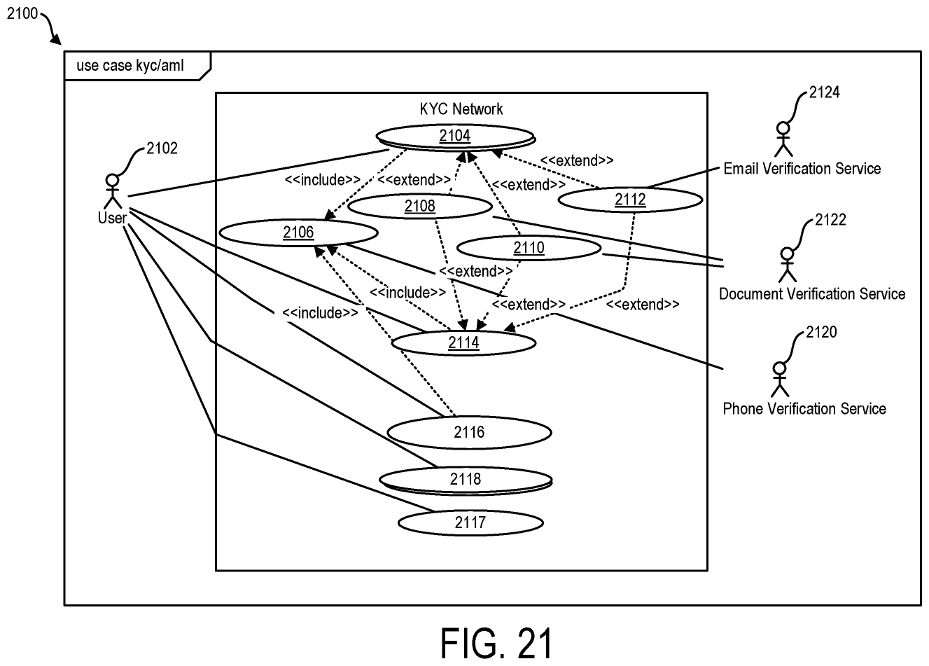

FIG. 21 is a use case diagram of a know your customer (KYC) network 2100, in accordance with some example implementations. As shown in FIG. 21, the network 2100 includes a user 2102 accessing the network. In some aspects, the user 2102 accesses the network via a computing system (e.g., a computer processor, tablet, smart phone, server, or the like). As further shown, the user may register on a platform 2104 of the KYC network 2100. In some implementations, registration may include verifying a phone number at 2106 of the user 2102 with a phone verification service 2120. The registration may further include verifying an ID document 2108, verifying an email address 2112, and verifying a physical address 2110 of the user 2102. The KYC network 2100 also includes establishing a recover access 2114. In some aspects, verifying the ID document 2108 and verifying the physical address 2110 may include communications with a document verification service 2122 that verify ownership of an identification document of the user 2102 and verify a physical address of the user 2102 by analyzing a document provided by the user 2102 to confirm the user 2102 is associated with the physical address of the document provided. Verifying an email address 2112 may include communications with an email verification service 2124 that verifies an email address of the user 2102 by solving a cryptographic challenge (e.g., a one-time code).

As further shown in FIG. 21, the network 2100 further includes an authorize new device feature 2116, a managed authorized devices feature 2118, and a managed personal data feature 2119. The authorize new device feature 2116 may allow the user 2102 to assign multiple key pairs (e.g., devices) to his/her identity. In such a case, it may not be required to pass the full verification process. The user 2102 may verify the primary method, send an authorization request, and confirm it on another authorize device. The managed authorize devices feature 2118 may be configured to allow the user 2102 to browse a list of authorized devices, select them, authorize them, and/or remove items from the list. The manage personal data feature 2119 may be configured to allow the user 2102 to browse a list of personal data uploaded to the system, manage permissions, update and delete any or all of the personal data.

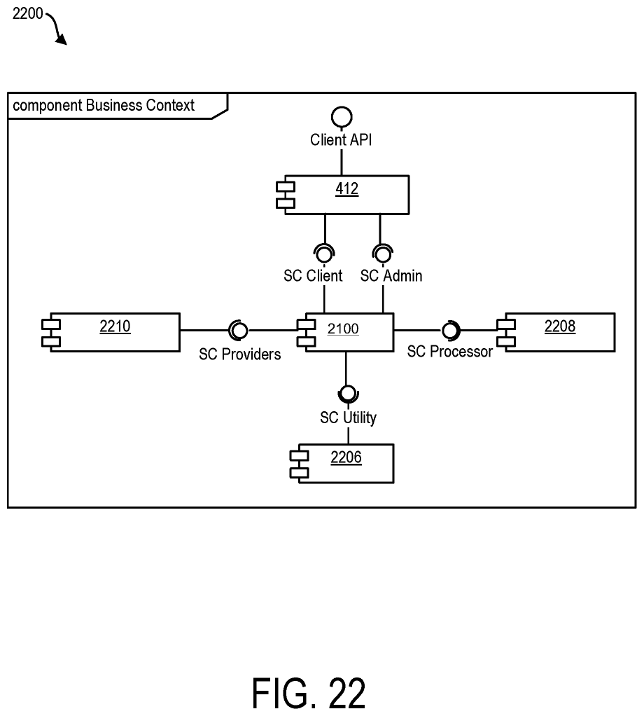

FIG. 22 is a diagram of know your customer (KYC) network environment 2200, in accordance with some example implementations. As shown, the context 2200 includes a client organization 412, a KYC network 2100, a utility network 2206, a data processor 2208, and email/SMS/push messages providers 2210. In some aspects, the client organization 412 may represent software and hardware infrastructure, providing access to DL networks to clients. End-users may not have direct access to DL infrastructure to execute SC functions. Thus, end-users may communicate with the DL through client organization 412 infrastructure. Client organization 412 may also participate in transaction execution, validation, and signing on DL networks. The utility network 2206 may represent another DL network or subsystem, for example, a money transfer network, which utilizes KYC network 2100 functionality and stored information. The data processor 2208 may include a person or a software service configured with permissions to process data provided by a client or another data processor 2208. Permissions may be approved by the user and may be described in a smart contract. Email/SMS/push messages providers 2210 may include outer interfaces providing email/SMS/push messages services.

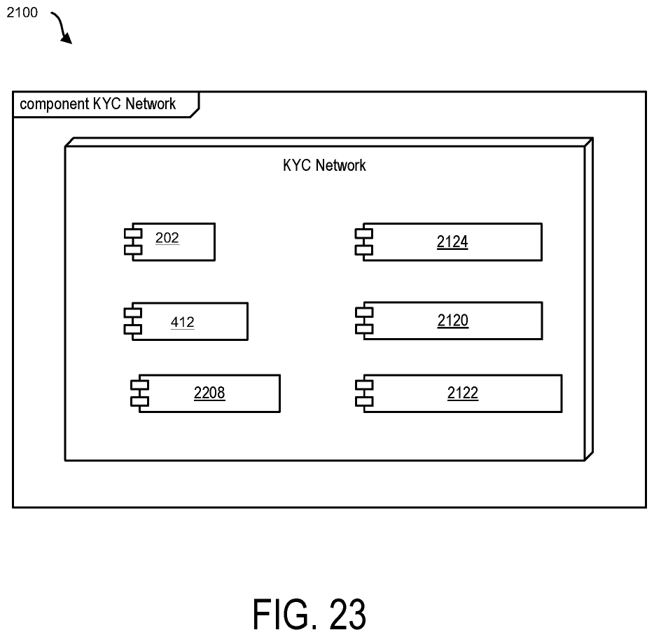

FIG. 23 is a diagram of components of an example know your customer (KYC) network 2100, in accordance with some example implementations. The KYC network 2100 may be represented by a group of independent services/organizations. Each service/organization may be responsible for a specific function on the KYC network 2100. As shown, the KYC network 2100 includes a multi-decentralized data vault (MDDV) 202, the client organization 412, the data processor 2208, the email verification service 2124, the phone verification service 2120 and the document verification service 2122. MDDV 202 may represent the storage of users' personally identifiable information (PII) and may provide CREATE, READ, UPDATE, DELETE operations based on permissions described in SC logic. The MDDV 202 may be configured as a mechanism to securely transfer, store, and read data in a decentralized manner. The Distributed Ledger Technology (DLT) may form the basis of the MDDV 202. Distributed Ledgers (DL) keep immutable and cryptography verifiable records of all create, read, update, delete operations with data.

The Smart Contract (SC) logic of a DL defines rules and permissions of how and by what means data can be processed (read, updated, deleted). The MDDV 202 may be replaced by other storage in the scope of this realization. But it may have a competitive advantage in terms of personal data usage: decentralized reading of such data. It may provide additional safety regarding personal data accessibility. The Data Processor 2208 may be a person or organization that deals with personal data as instructed by a controller for specific purposes and services that involve personal data processing. The controller or data controller may be basically the organization (a legal person, agency, public authority, etc.) or the person which defines what needs to be done with the personal data and apparently is key in personal data protection. Thus, the processor 2208 may include a natural or legal person, public authority, agency or other instance which processes personal data on behalf of the controller.

Communication with the MDDV 202 goes not only through the DL network but also using a REST API. Communication between all participants (except end-users) may happen through the KYC network (e.g., network 1404, 1400, and/or 1500). Participants may subscribe to DL events and handle them using Smart Contract (SC) interface functions.

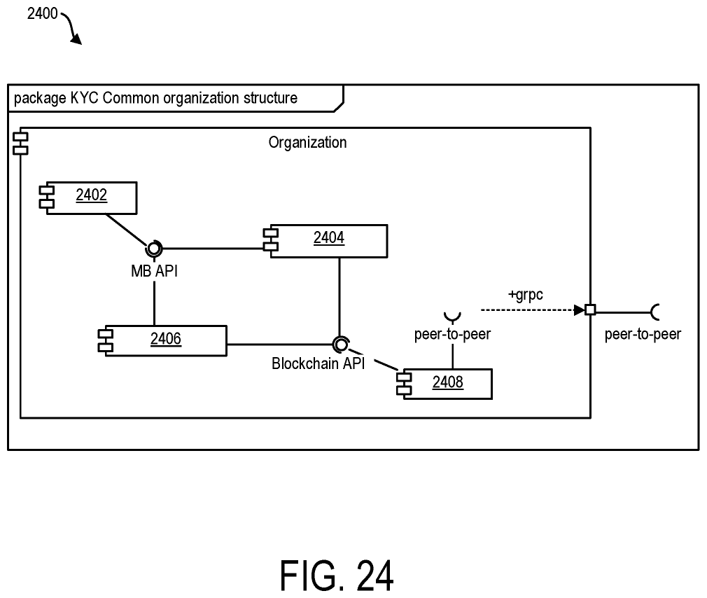

FIG. 24 is a diagram of a typical organization structure 2400 of an example know your customer (KYC) network, in accordance with some example implementations. As shown, the organization structure 2400 may include a message broker 2402, a microservices 2404, a blockchain event listener 2406, blockchain nodes 2408. The message broker 2402 may be configured to be responsible for communication between an organization's services. The micro services 2404 may include services that are responsible for an organization's workflows including blockchain interaction. The blockchain event listener 2406 may be configured to listen to events caused by new transactions committed to the blockchain ledger and may be further configured to create tasks for the microservices 2404. The blockchain nodes 2408 may include a set of the organization's nodes and may participate in maintaining distributed ledgers (e.g., Blockchain). Each member organization in a blockchain network may be responsible to set up their peers for participating in the network. All of these peers may be configured with appropriate cryptographic materials like private, public keys and certificates and approved by other participants. Peers in the member organization may receive transaction invocation requests from the clients (users, managers, software services) inside the organization. A member organization can be any specific application/portal serving specific organization/business activities. Smart Contract may be installed on peers handling the transaction invocation requests. All the peers may maintain (store and update) their own copy of the ledger they are participating in. If the transaction succeeds, the peer may sign it with the private key. If all the peers have agreed on the same transaction results (reach the consensus), peers may update the entire ledger.

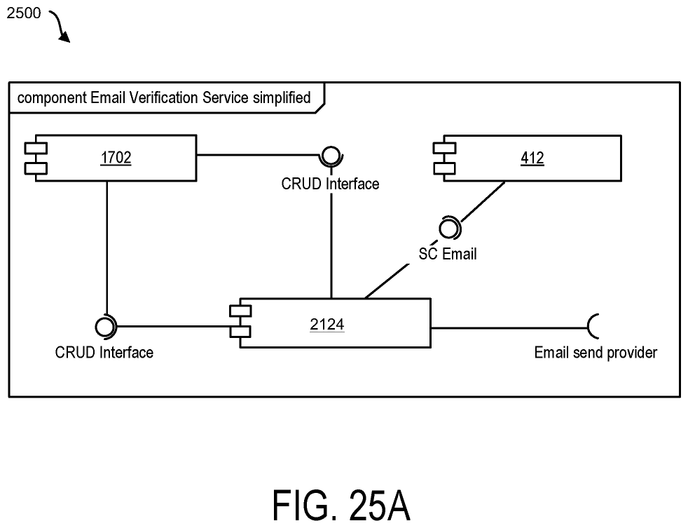

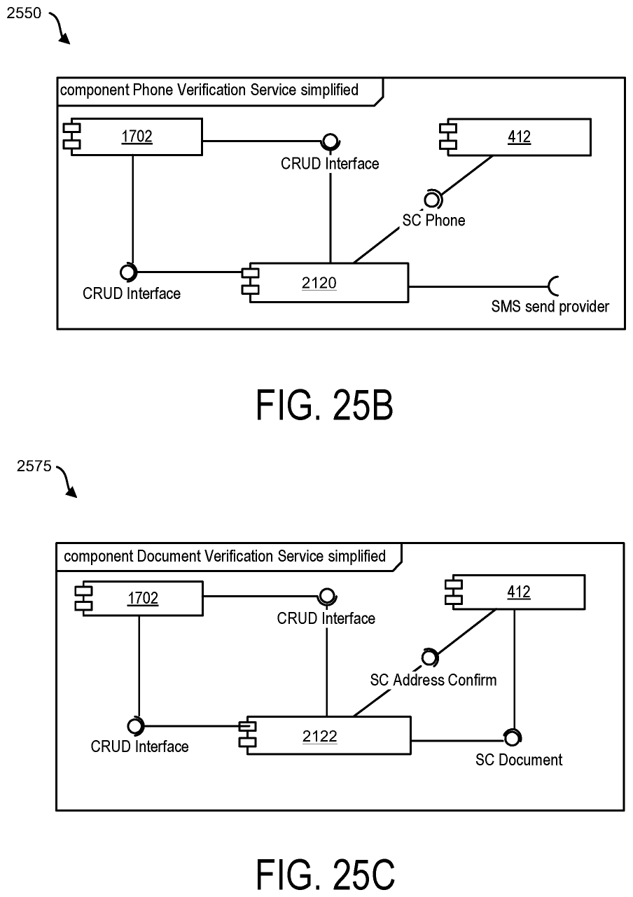

FIG. 25A is a diagram 2500 of example communication connections of email verification service 2124, in accordance with some example implementations. As shown, the diagram 2500 includes a data storage component 1702 (e.g., MDDV 202), an email verification service 2124, and the client organization 412. The data storage component 1702 may include the MDDV 202 or other data storage configured to provide a CRUD interface for PII of a user (user 1302). The email verification service 2124 may be responsible for generating and managing cryptographic challenges (e.g. one-time codes) and may be configured with permission to read the user's email address to send a challenge solution. The client organization 412 may be configured to provide users with access to the client's part of the SmartContract email interface. The CRUD interface may be configured to enable a participant having proper permissions to create, read, update, and delete an email file. The SC email interface shown in FIG. 25A may include a SmartContract interface configured to perform the email proving and the email verification process. The email sent provider may include a vendor service that provides email messages sending capabilities.

FIG. 25B is a diagram 2550 of communication connections of phone verification service 2120, in accordance with some example implementations. As shown, the diagram 2550 includes a data storage component 1702 (e.g., MDDV 202), a phone verification service 2120, and a client organization 412. The data storage component 1702 may include the MDDV 202 or other data storage configured to provide a CRUD interface for PII of a user (user 2102). The phone verification service 2120 may be responsible for generating and managing cryptographic challenges (e.g. one-time codes) and may be configured with permission to read the user's phone number to send a challenge solution. The client organization 412 may be configured to provide users with access to the client's part of the Smart Contract phone interface. The CRUD interface may be configured to enable a participant having proper permissions to create, read, update, and delete a phone number file. The SC phone shown in FIG. 25B may include a Smart contract interface configured to perform the phone proving and the phone verification process. The SMS sent provider may include a vendor service that provides SMS sending capabilities.

FIG. 25C is a diagram 2575 of communication connections of a simplified document verification service 2122, in accordance with some example implementations. As shown, the diagram 2575 includes a data storage component 1702 (e.g., MDDV 202), a document verification service 2122, and the client organization 412. The data storage component 1702 may include the MDDV 202 or other data storage configured to provide a CRUD interface for PII of a user (user 1302). The document verification service 2122 may be responsible for parsing and verifying a user's documents and performing AML checks. The client organization 412 may be configured to provide users with access to the client's part of the Smart Contract document and Smart Contract AddressConfirm. The CRUD interface may be configured to enable a participant having proper permissions to create, read, update, and delete documents and image/video files. The SC document shown in FIG. 25C may include a Smart contract interface configured to perform the document proving and the document verification process. The SC AddressConfirm may include a Smart Contract interface configured to perform the user's address validation.

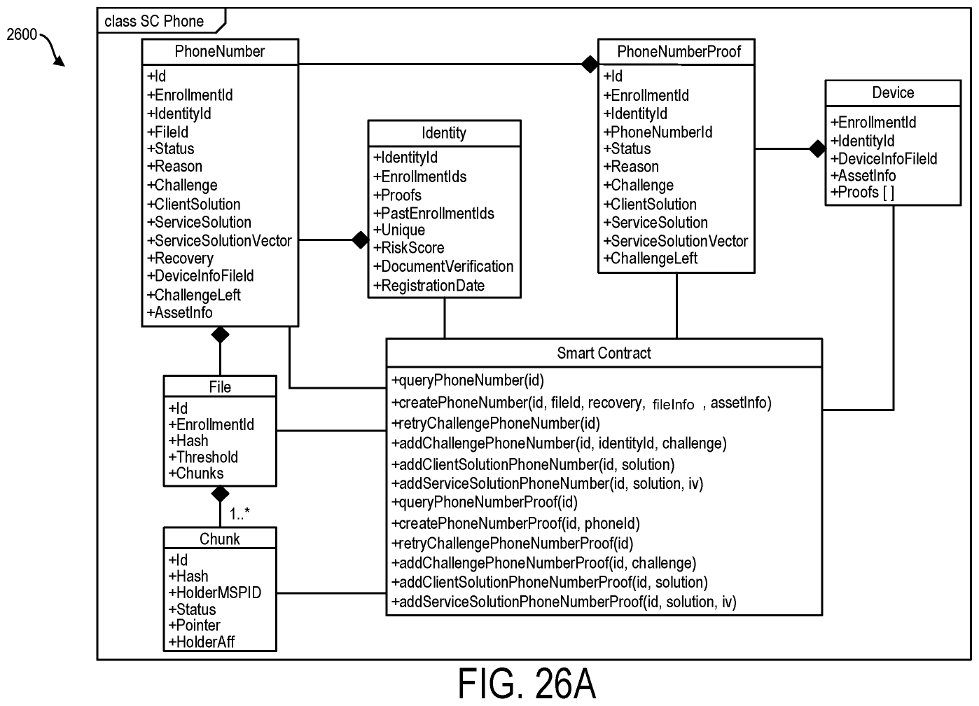

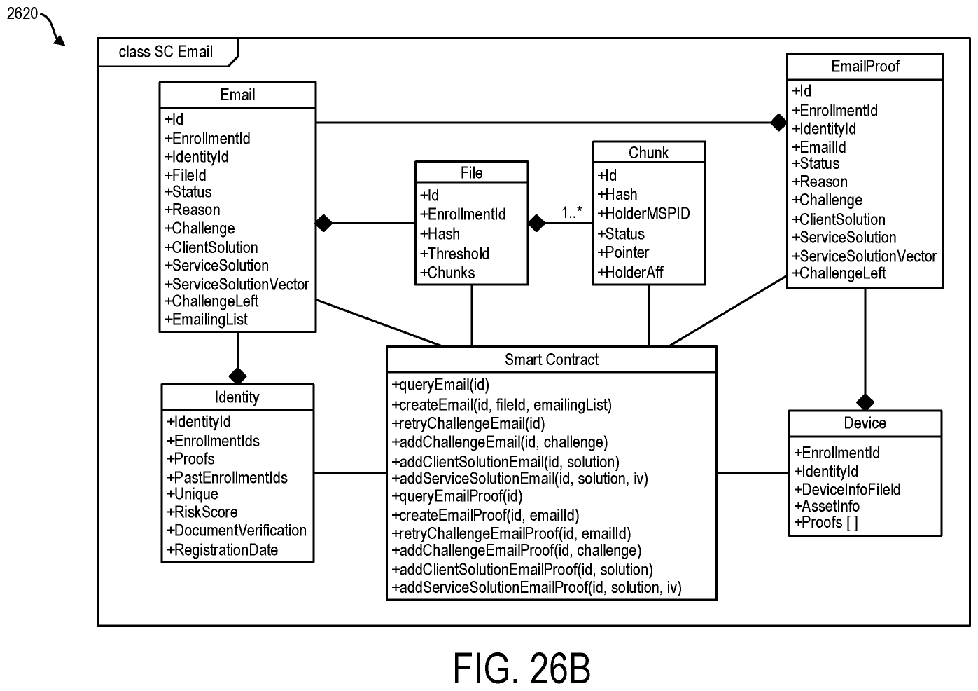

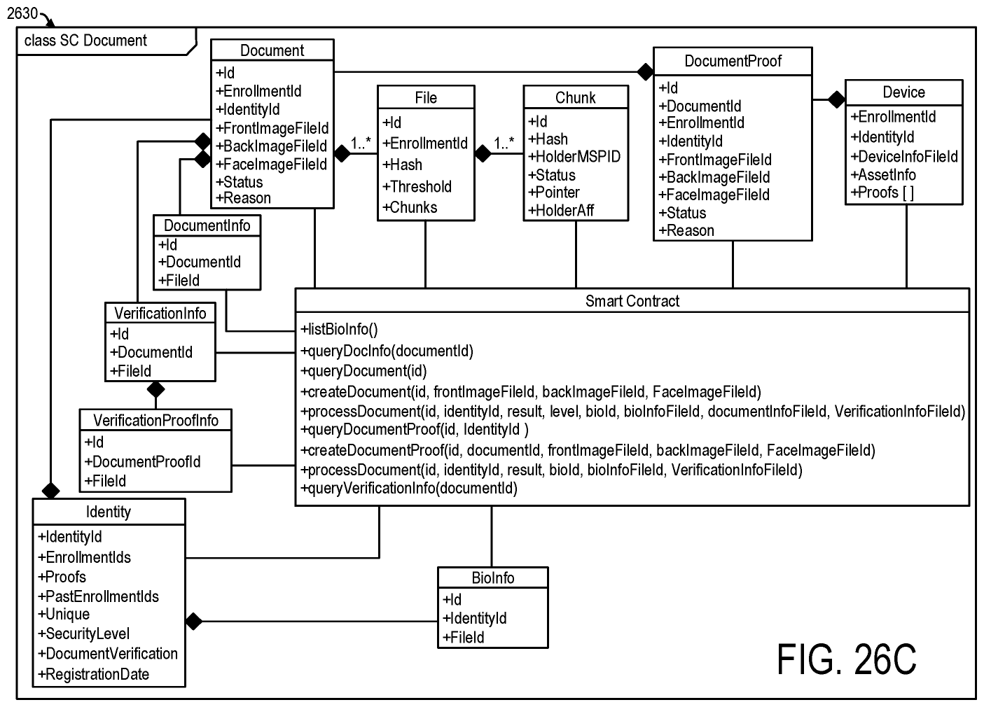

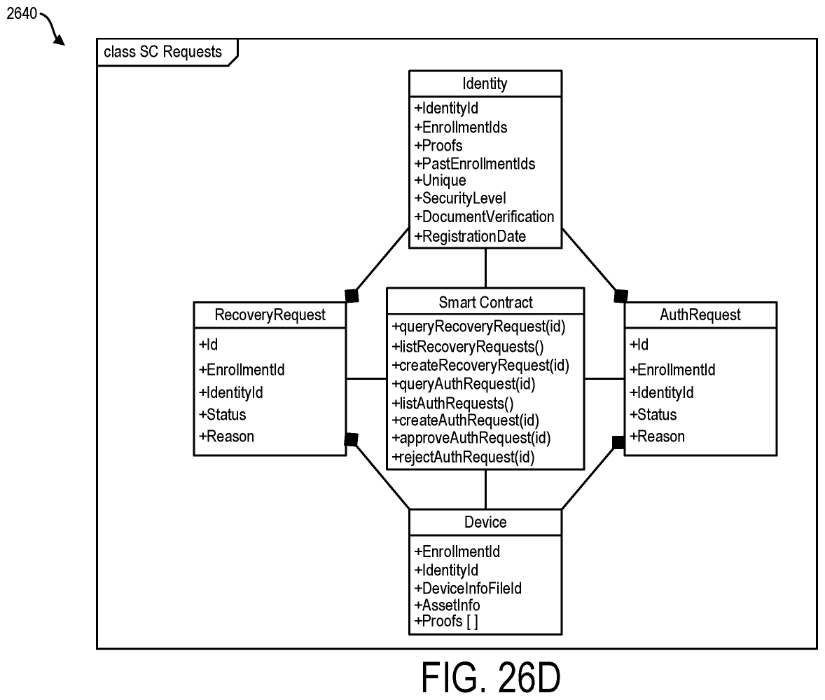

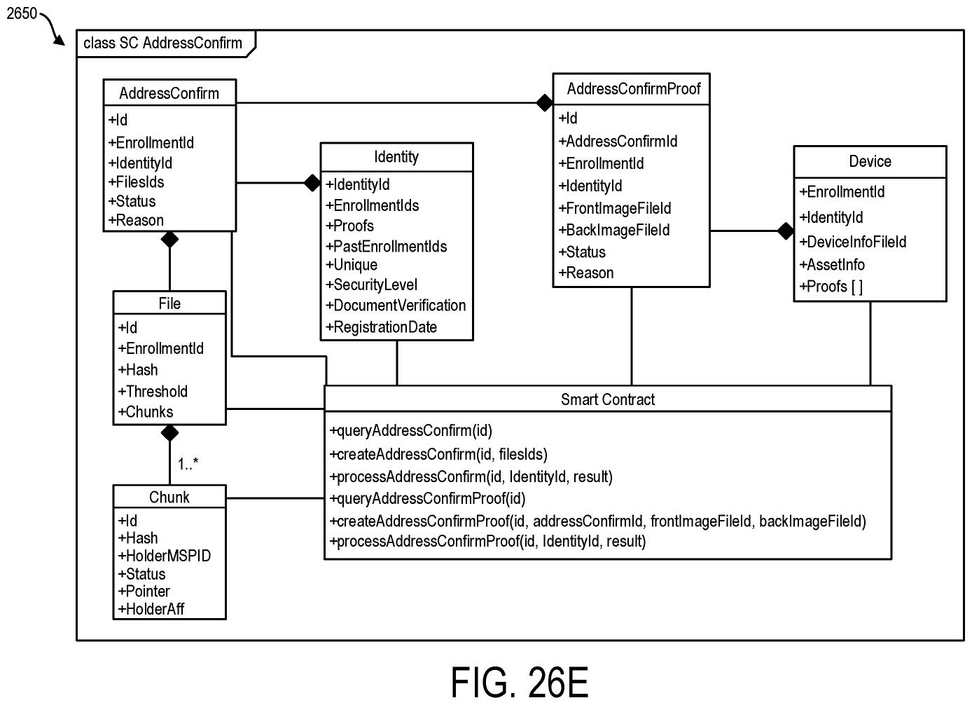

FIG. 26A is a diagram of example smart contract class logic 2600 for phone verification in a distributed ledger network, in accordance with some example implementations. As shown, the class logic 2600 includes classes: Device; Identity; File; Chunk; PhoneNumber; PhoneNumberProof; and SmartContract. The Device class may identify a person's device and may store information about the device and the proving's completed on the device within a recovery process. The Identity class may identify a real person that participates in the KYC network. The Identity class may also include links to all approved verification methods, a person risk score, information about all current and previous devices, a registration date, a group, and it may also define that the person is unique. The PhoneNumber class may contain information about a user's phone (e.g. due to verification and recovery). A PhoneNumberProof class may contain information about the user's phone (e.g., due to transaction verification and login to the device). It may contain the same information as the phone number class but this information may not be linked to Identity. The File class may contain information about the file owner, a hash, and a chunks array. The Chunk class may contain information about a chunk holder (e.g., DVS), a hash, status, and a pointer (e.g., Key in a Key-value paradigm) in the DVS's long-term storage.

FIG. 26B is a diagram of example smart contract class logic 2620 for email verification in a distributed ledger network, in accordance with some example implementations.

FIG. 26C is a diagram of example smart contract class logic 2630 for document verification in a distributed ledger network, in accordance with some example implementations.

FIG. 26D is a diagram of example smart contract class logic 2640 for a request in a distributed ledger network, in accordance with some example implementations.

FIG. 26E is a diagram of example smart contract class logic 2650 for address verification in a distributed ledger network, in accordance with some example implementations.

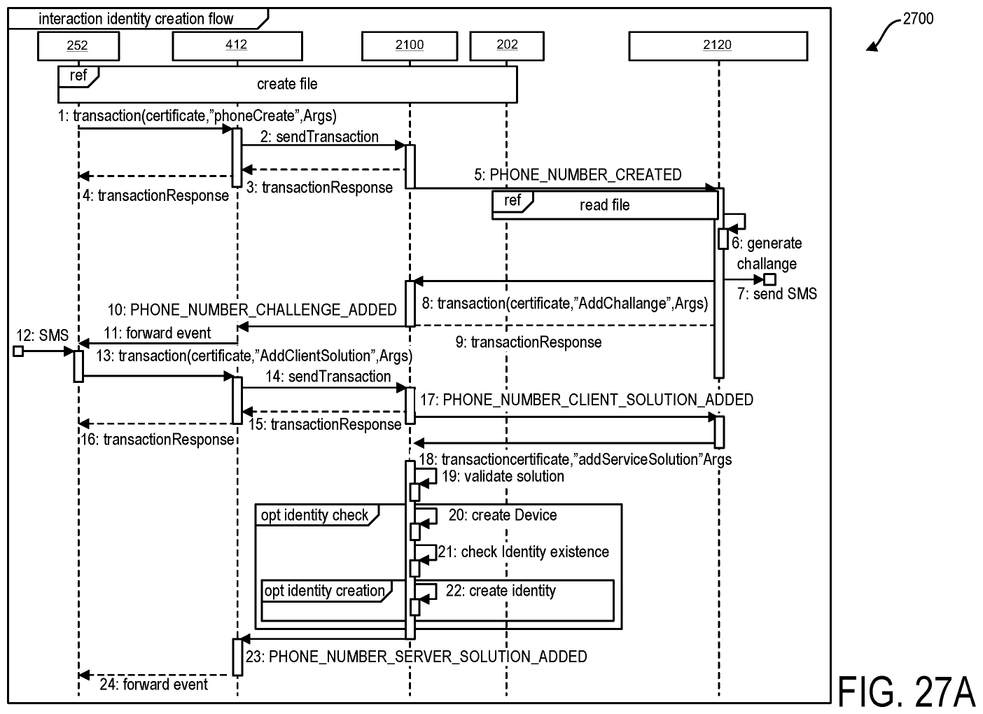

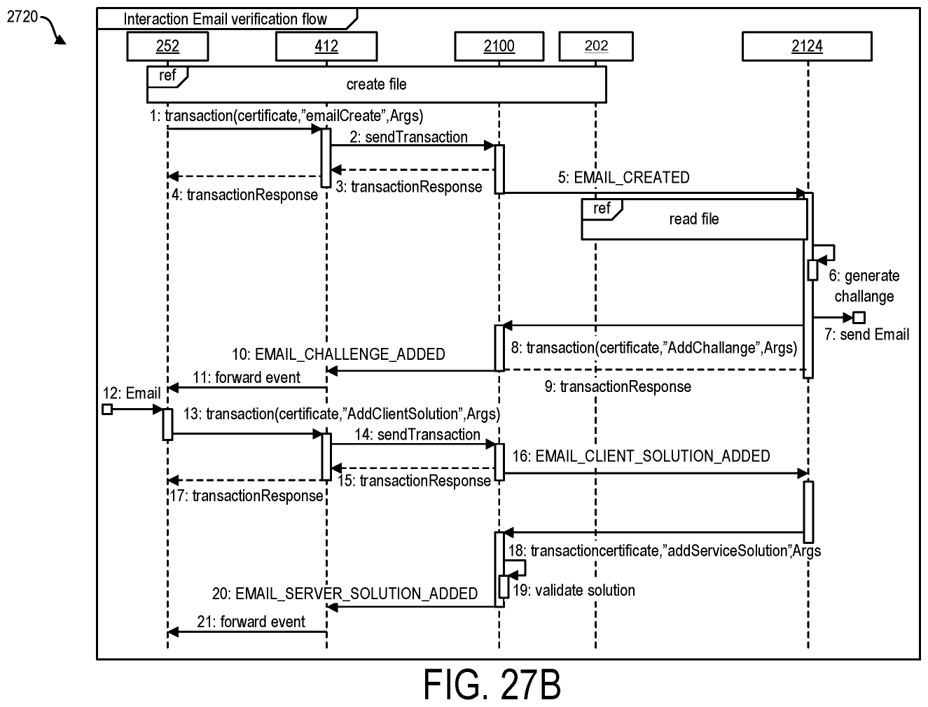

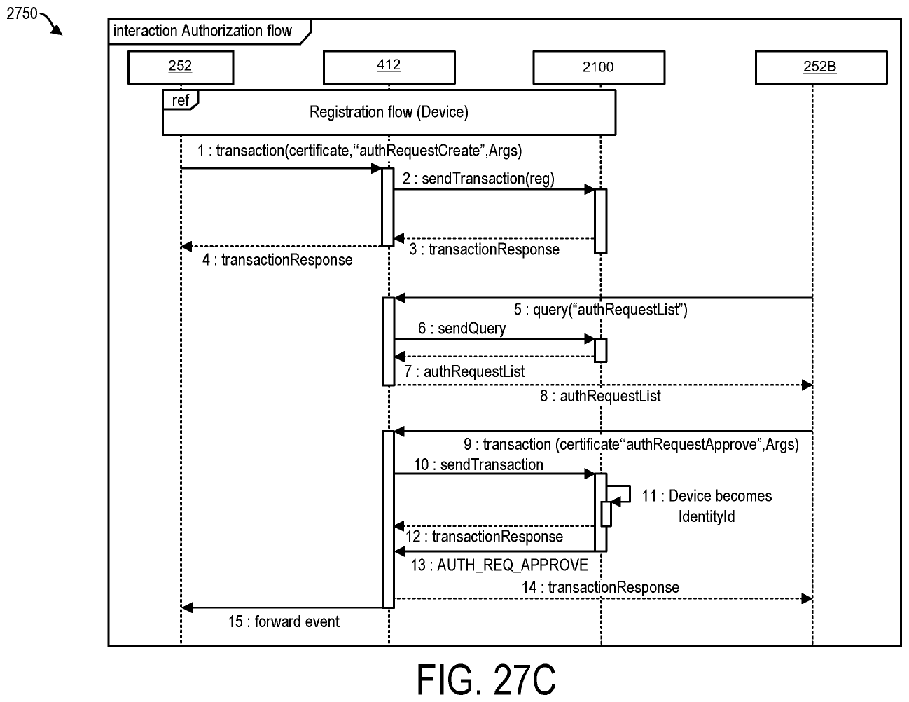

FIG. 27A is a diagram of an example identity creation communication exchange 2700 in a network in accordance with certain aspects of the present disclosure. In some aspects, identity creation (e.g., as shown in FIG. 27A) may be performed by verifying ownership of a phone number, an email address, a document, or any other method that can identify and authenticate a person. FIG. 27A depicts registration using phone number authentication but registration may be performed using any other method that can identify and authenticate a person.

FIG. 27B is a diagram of email verification communication exchange 2720 in a network in accordance with certain aspects of the present disclosure. As shown, communication exchange 2720 includes a client 252, the client organization 412, the KYC network 2100, an email verification service 2124, and the MDDV 202.

At steps 1-5, the client 252 initiates a transaction with fileId to create an email asset. This action grants permission to the email verification service 2124 to read the file with an email address from the MDDV 202. The email verification service 2124 has permission to read file until an email message is sent and the Email asset is processed to the next status.

At steps 6-10, the email verification service 2124 subscribes to the EMAIL CREATED event. It reads the file containing previously confirmed email from the MDDV 202, generates a challenge, sends an email containing a challenge to the client's 252 device, adds challenge data to the Email asset in the KYC network 2100 when the event is received.

At step 11, the client 252 may receive an event from the KYC network 2100 (it has subscribed for such events earlier).

At steps 12-17, the client 252 receives an email with the solution. The client 252 sends a transaction that adds client solution to the Email asset in KYC network 2100. KYC network 2100 emits event EMAIL CLIENT SOLUTION ADDED. The Email verification service 2124 receives it.

At steps 18-21, the email verification service 2124 sends a transaction to the KYC network 2100 that adds service solution to Email asset. Smart contract logic cryptographically checks both client 252 and service solutions and makes a final decision. The client 252 receives an email verification result.

FIG. 27C is a diagram of an authorization communication exchange 2750 in a network in accordance with certain aspects of the present disclosure. As shown, communication exchange 2750 includes a client 252, the client organization 412, the KYC network 2100, and an authorized client 252B. The communication exchange 2750 describes a common mechanism of the new device authorization process. The flow sends a new or watches an existing authorization request.

At step 1, the client 252 may start registration flow. Device identity is created as a result. At step 2, the client organization 412 sends a transaction to the KYC network 2100 for DeviceAuthorizationRequest asset creation.

At steps 5-7, the authorized device 252B may request a list of its device authorization requests via the client organization 412.

At steps 8-9, The authorized device 252B may approve the authorization request via authorized device 252B. The device identity may turn into the permanent Identity.

At steps 10-13, the KYC network 2100 may emit the AUTH_REQ_APPROVE event. The client organization 412 may be subscribed to receive such events.

At steps 14-15, the client organization 412 may send a response to the authorized client 252B and may forward the event to the client 252. The client 252 receives an event as a flow result.

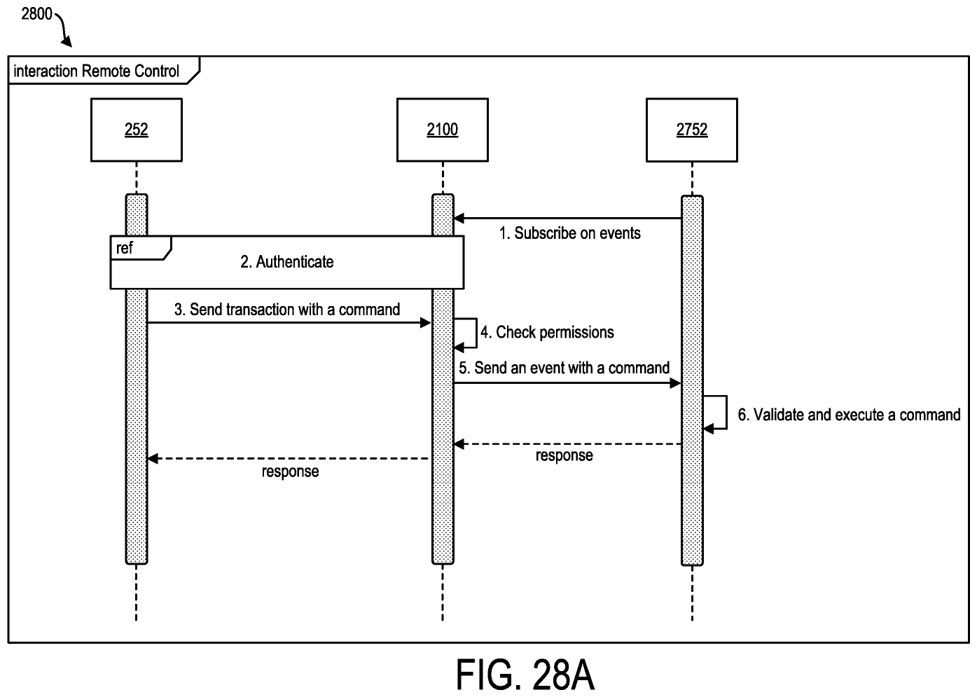

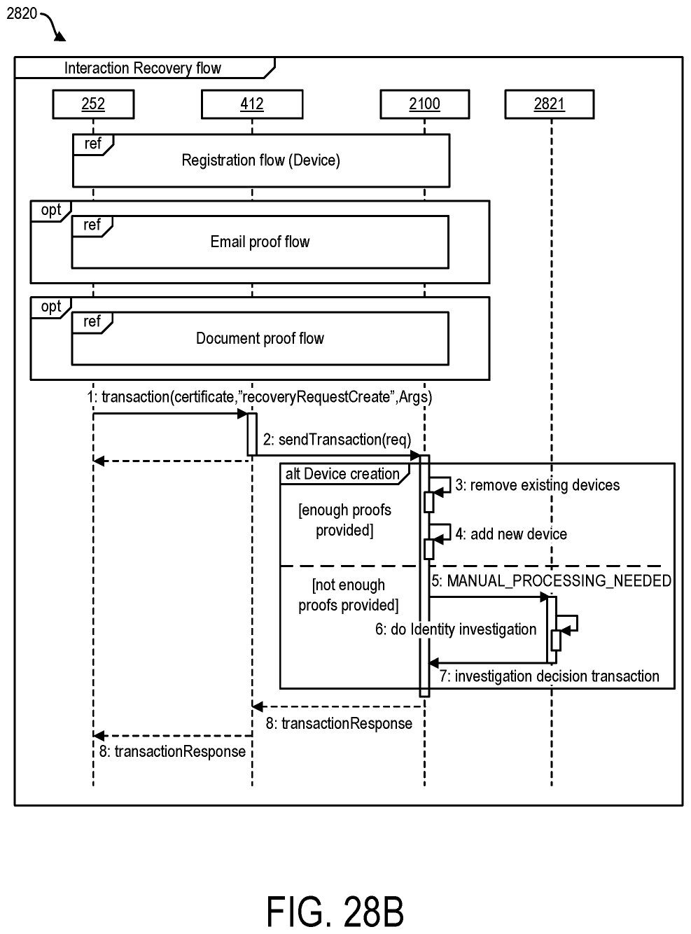

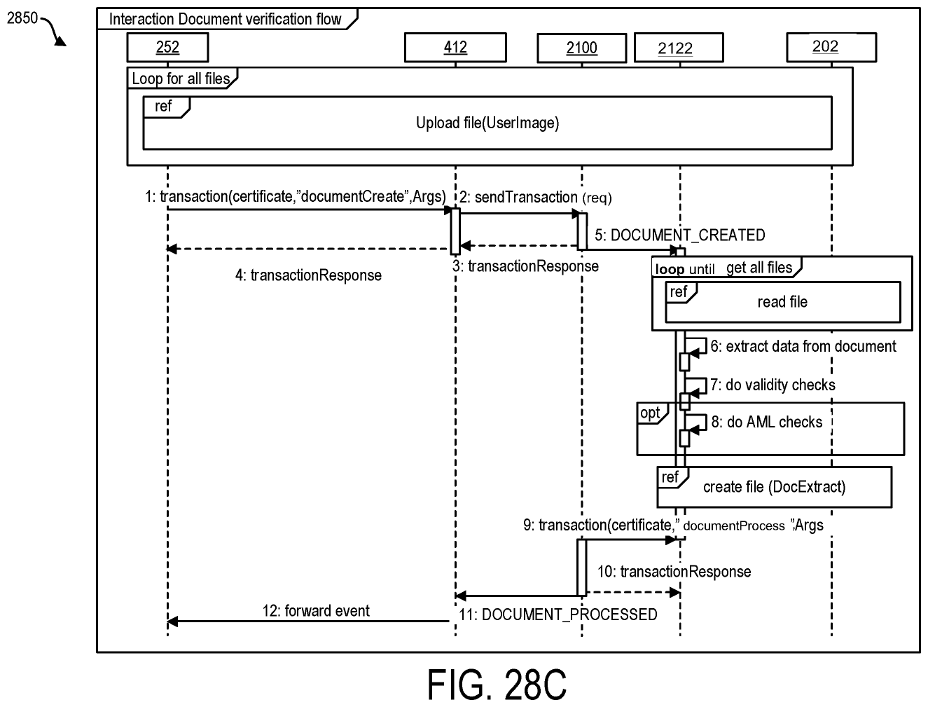

FIG. 28A is a diagram of a remote control communication exchange 2800 in a network in accordance with certain aspects of the present disclosure. If a user has at least two devices and these devices are connected to one user's identity using authorization flow 2750, the user (e.g., user 1302) may use one device to send commands to another device. For instance, sign in to an app, log out from an app, lock a device.

As shown in FIG. 28A, the remote control communication exchange 2800 includes a first authorized client 252 (e.g., controller), the KYC network 2100, and a second authorized client 2752 (e.g., receiver).

At step 1, the receiver device (e.g., second authorized client 2752) which is supposed to receive and execute commands, subscribes to receive events from the KYC network 2100.

At step 2, the controller device (e.g., first authorized client 252) which is supposed to send commands, performs additional authentication if needed from the KYC network 2100.

At step 3, the controller device (e.g., first authorized client 252) sends a transaction containing information about a command(its name and parameters) to the KYC network 2100

At step 4, the KYC network 2100 verifies permission of the controller device (e.g., first authorized client 252) to perform such command on the receiver device (e.g., second authorized client 2752).

At step 5, if validation is passed, the KYC network 2100 sends an event containing information about a command(its name and parameters) to the receiver device (e.g., second authorized client 2752).

At step 6, the receiver device (e.g., second authorized client 2752) validates a command and executes it.

At steps 7-8, the receiver device (e.g., second authorized client 2752) sends a response to the controller device (e.g., first authorized client 252) through the KYC network 2100.

FIG. 28B is a diagram of a recovery communication exchange 2820 in a network in accordance with certain aspects of the present disclosure. The diagram 2820 describes a common mechanism of the access recovery process (e.g., when a mobile phone was lost). The flow sends a new or watches an existing recovery request. It may keep watching the status when its running.

As shown, the communication exchange 2820 includes a client 252, the client organization 412, the KYC network 2100, and a recovery manager 2821.

At step 1, the client 252 undergoes registration flow with the KYC network 2100 that creates a new device identity. At step 2, the client 252 confirms email and document via Email proof and Document proof flows with the KYC network 2100, respectfully. The client 252 confirms only that proofs that were verified earlier.

At step 3, the client 252 generates a transaction that creates a RecoveryRequest asset in the KYC network 2100 and sends to the client organization 412.

At step 4, if there were enough proofs provided by the customer, the KYC network 2100 removes all existent bindings with the Identity and adds a new Device identity to it.

At steps 5-7, otherwise, the request is sent to manual processing to the recovery manager 2821. It executes the identity investigation (contact with the person to verify his identity and to find out the causes of proofs verification fail) and makes a decision whether Identity is valid or not.

At step 8-9, the client 252 receives a result from the recovery manager 2821 of the recovery request transaction.

FIG. 28C is a diagram of a document verification communication exchange 2850 in a network in accordance with certain aspects of the present disclosure. The diagram 2850 describes a common mechanism of the document verification process. The main purpose is to verify document ownership. The document verification service 2122 performs document data parsing and the following validation. Passport, ID and driving license copies can be used for such a purpose.

As shown, communication exchange 2850 includes a client 252, the client organization 412, the KYC network 2100, a document verification service 2122, and the MDDV 202.

At an initial step, a file with a new document image is uploaded to the MDDV 202 by the client 252 (e.g., several times if there are more than one file with document image). The user may upload his photo to compare it with a photo from documents.

At steps 1-5, the client 252 may generate a transaction to create a document asset at the document verification service 2122. This asset may include file ids for each uploaded document image. This action may grant permission to the document verification service 2122 to read files with document images from the MDDV 202.

At steps 6-8, the document verification service 2122 may subscribe to event DOCUMENT CREATED. It may read files from the MDDV 202 (several times if there are more than one file with document image), parse data from document images, perform validity and AML checks, create a file with extracted data and AML check results in the MDDV 202.

At step 9, the document verification service 2122 sends a transaction to the KYC network 2100 that links document images processing data stored in MDDV 202 with the Document asset.

At steps 10-12, the KYC network 2100 sends a transaction response to the document verification service 2122 and generates the DOCUMENT_PROCESSED event to notify the user (e.g., client 252) about flow completion.

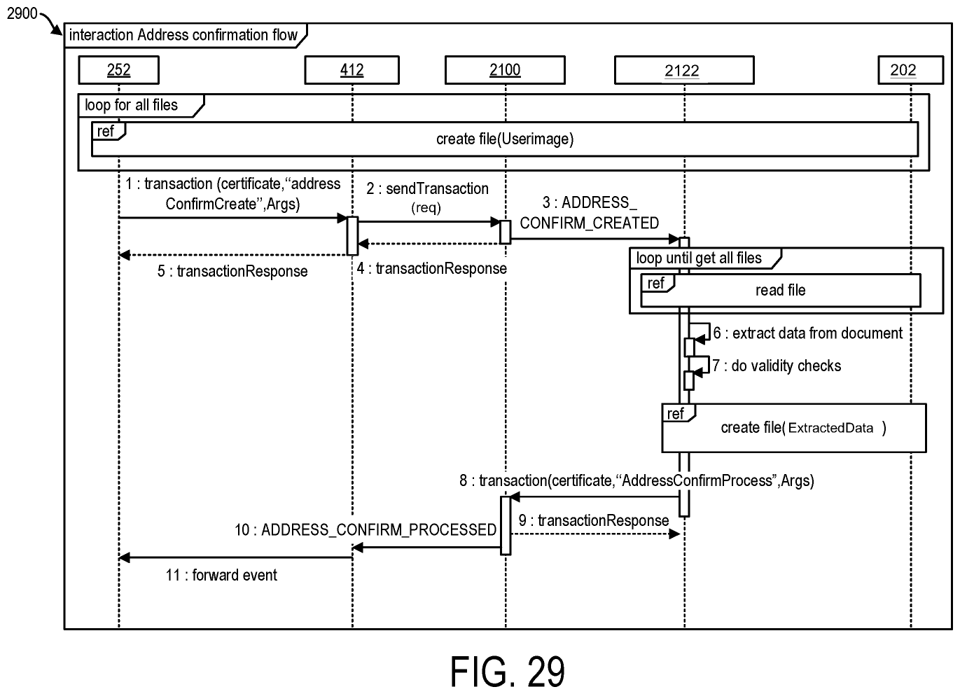

FIG. 29 is a diagram of an address verification communication exchange 2900 in a network in accordance with certain aspects of the present disclosure. The diagram 2900 describes a common mechanism of an address verification process. The document verification service 2122 may perform document data parsing and the following validation. Copies of the following documents can be used for such purpose: utility bill, tax bill, building society or bank statement (e.g., credit card statement), mortgage statement, original notification letter from the relevant benefits agency, insurance certificate.

As shown, communication exchange 2900 includes a client 252, the client organization 412, the KYC network 2100, the document verification service 2122, and the MDDV 202.

At an initial step, a file with a user image (e.g., a utility bill) is uploaded to the MDDV 202 by the client 252 (repeated in case of multiple image files).

At steps 1-5, the client 252 generates a transaction for the KYC network 2100 to create the AddressConfirm asset. This action grants permission to the document verification service 2122 to read files with document images from MDDV 202. The KYC network 2100 may send a transaction response, via the client organization 412, to the client 252.

At step 6-7, the document verification service 2122 subscribes to the ADDRESS CONFIRM CREATED event. It reads the file from the MDDV 202 (several times if there are more than one file with document image), parses data from document images, performs validity checks, and creates the file with extracted data in the MDDV 202.

At steps 8-9, the document verification service 2122 sends a transaction with document file processing results to the KYC network 2100. This transaction adds document images processing data stored in the MDDV 202 with the Document asset.

At step 10-11, the KYC network 2100 generates the ADDRESS CONFIRM PROCESSED event to notify the user about flow completion.

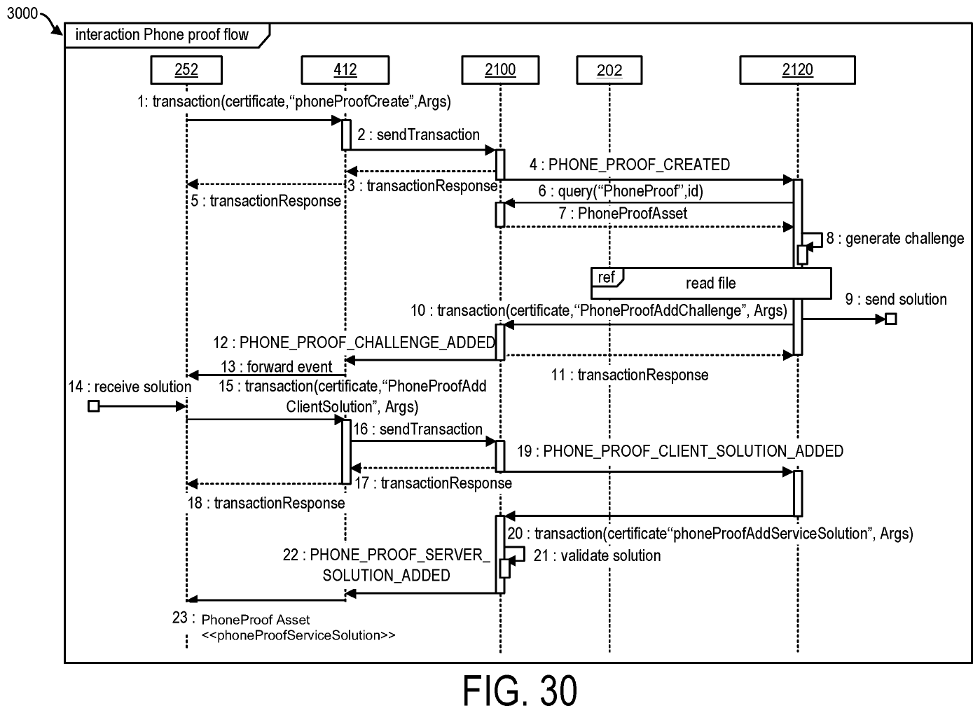

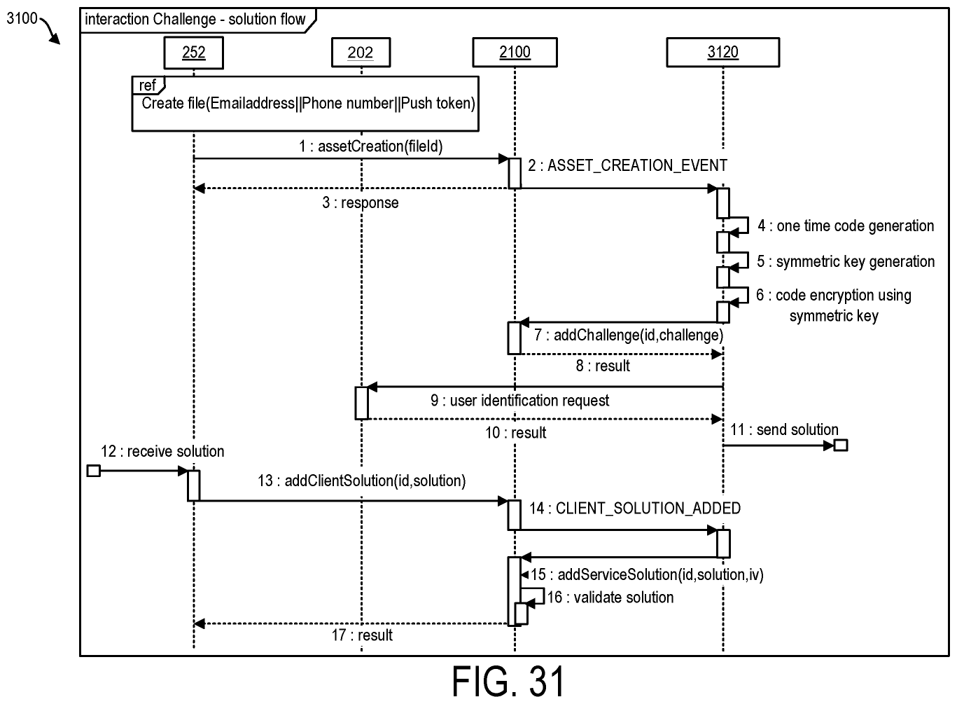

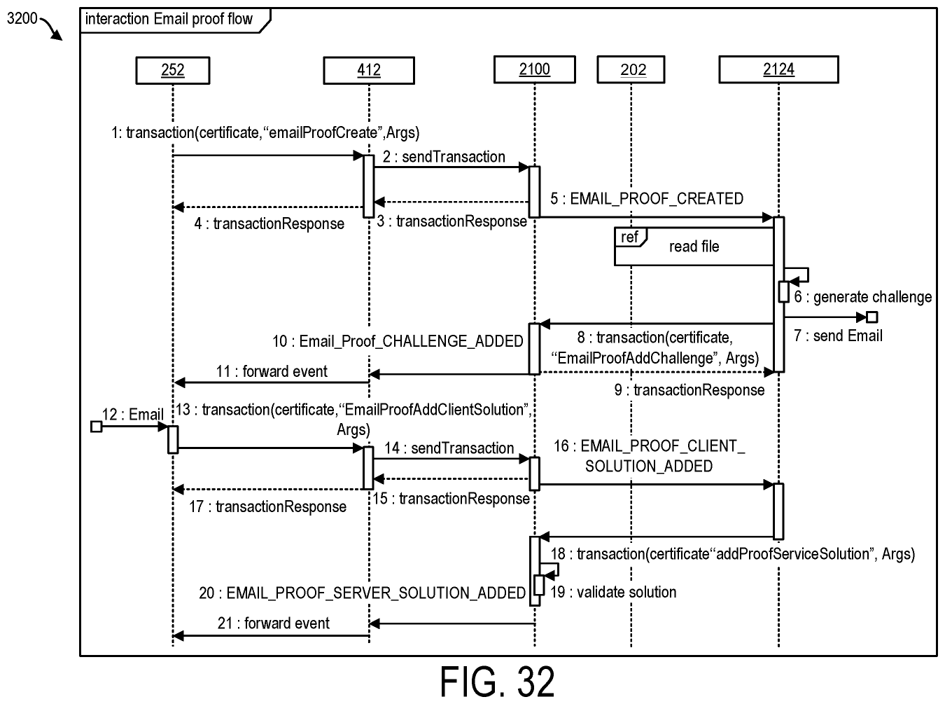

FIG. 30 is a diagram of a phone verification communication exchange 3000 in a network in accordance with certain aspects of the present disclosure. The diagram 3000 describes a common mechanism of a mobile phone verification process when a client verify ownership of previously uploaded and verified number (e.g., via process 2700). The phone verification service 2120 generates a challenge after the phone proof asset (PhoneProof) is received. Then a solution is sent to the client's side.

As shown, communication exchange 3000 includes a client 252, the client organization 412, the KYC network 2100, a phone verification service 2120, and the MDDV 202.

At step 1-5, the client 252 sends a request to the KYC network 2100 (via the client organization 412) for PhoneProof asset creation.

At step 4, 6, the KYC network 2100 emits the PHONE PROOF CREATED event. The phone verification service 2120 has subscribed to receive such events earlier.

At step 8, the phone verification service 2120 generates a challenge. Then it reads a file with a phone number from the MDDV 202.

At step 9, the phone verification service 2120 sends a solution to the client's side.

At steps 10-13, the phone verification service 2120 adds a challenge to the PhoneProof asset in the KYC network 2100.

At step 14, the client 252 receives a solution (SMS).

At steps 15-18, the client 252 sends a transaction that adds client solution to the PhoneProof asset in the KYC network 2100.

At step 19, the KYC network 2100 emits an event PHONE PROOF CLIENT SOLUTION ADDED. The phone verification service 2120 receives it.

At step 20-21, the phone verification service 2120 sends a transaction to the KYC network 2100 that adds service solution to the PhoneProof asset. Smart contract logic cryptographically checks both client and service solutions and makes a final decision.

At steps 22-23, the client 252 receives the PhoneProof verification result.

FIG. 31 is a diagram of a challenge verification communication exchange 3100 in a network in accordance with certain aspects of the present disclosure. The diagram 3100 describes a common mechanism of account verification using email, phone number or push notification. It's based on solving cryptographic challenges by a user. A Verification service 3120 may generate a one-time code (solution) then encrypt it with a symmetric key (service solution).

As shown, communication exchange 3100 includes a client 252, the KYC network 2100, a verification service 3120, and the MDDV 202.

As an initial step, the client 252 loads the user's email address/phone number/push notification token to the MDDV 202 and receives a fileId as a response.

At step 1, the client 252 sends a request to the KYC network 2100 to create the verification process asset and to initialize verification flow.

At step 2, the KYC network 2100 emits the ASSET CREATION EVENT event. The verification service 3120 has subscribed to receive such events earlier.

At steps 4-6, the verification service 3120 performs a one-time code generation when the event is received. Then it encrypts the code with a previously generated symmetric key.

At step 7, the verification service 3120 adds challenge data (encrypted one-time code) to the verification process asset in the KYC network 2100.

At steps 9-11, the verification service 3120 requests the user's email address/phone number/push notification token in MDDV 202 and then sends a client solution (one-time password) to the client 252.

At step 12, the client 252 receives a client solution.

At step 13, the client 252 sends a transaction that adds a client solution to the Verification process asset in the KYC network 2100.

At step 14, the KYC network 2100 emits the CLIENT SOLUTION ADDED event. The verification service 3120 receives it.

At steps 15-16, the verification service 3120 sends a transaction to the KYC network 2100 that adds a service solution (symmetric key) to the verification process asset. Smart contract logic decrypts service challenge using service solution, compares it with client solution and saves a comparison result to the verification process asset.

At step 17, the client 252 receives a verification result.

FIG. 32 is a diagram of an email verification communication exchange 3200 in a network in accordance with certain aspects of the present disclosure. As shown, communication exchange 3200 includes a client 252, the client organization 412, the KYC network 2100, an email verification service 2124, and the MDDV 202. In some implementations, the communication exchange 3200 may provide an example further email verification after an initial email address setup on a network (e.g., via the email verification communication exchange 2720 of FIG. 27B).

At steps 1-5, the client 252 initiates a transaction with fileId to create an emailProof asset. This action grants permission to the email verification service 2124 to read the file with an email address from the MDDV 202. The email verification service 2124 has permission to read file until an email message is sent and the EmailProof asset is processed to the next status.

At steps 6-10, the email verification service 2124 subscribes to the EMAIL PROOF CREATED event. The email verification service 2124 reads the file containing previously confirmed email from the MDDV 202, generates a challenge, sends an email to the client's 252 device, adds challenge data to the EmailProof asset in the KYC network 2100 when the event is received.

At step 11, the client 252 receives an event from the KYC network 2100 (it has subscribed for such events earlier).

At step 12, the client 252 receives an email with a solution.

At steps 13-17, the client 252 sends a transaction that adds client solution to EmailProof asset in the KYC network 2100. The KYC network 2100 emits the EMAIL PROOF CLIENT SOLUTION ADDED event. The Email verification service 2124 receives it.

At steps 18-19, the email verification service 2124 sends a transaction to the KYC network 2100 that adds service solution to the emailProof asset. Smart contract logic cryptographically checks both client and service solutions and makes a final decision.

At steps 20-21, the client 252 receives an email verification result via the client organization 412.

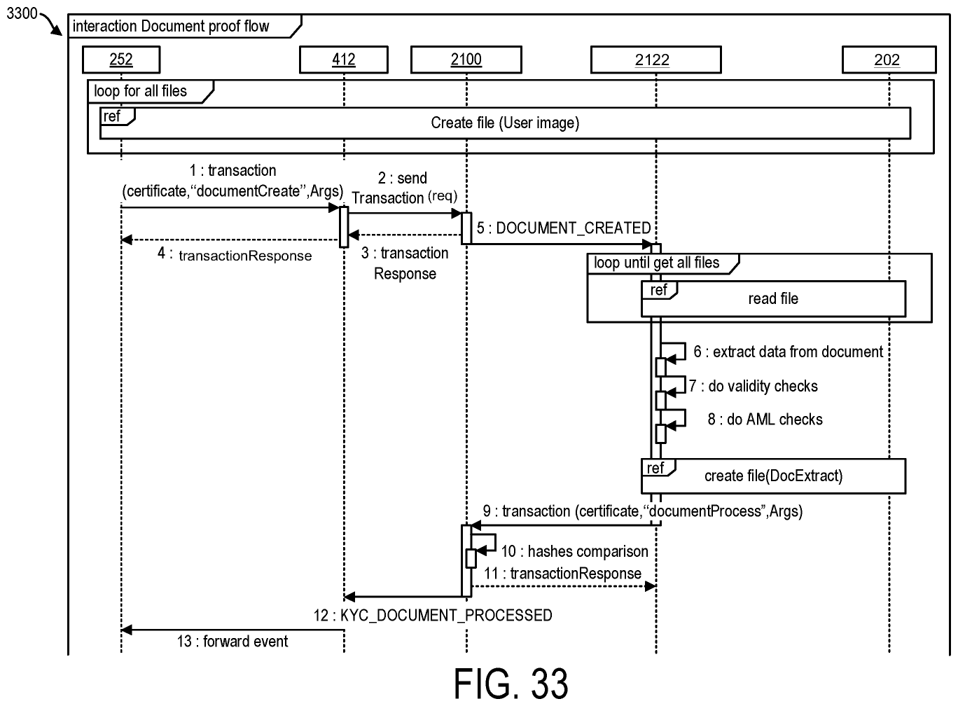

FIG. 33 is a diagram of a document verification communication exchange 3300 in a network in accordance with certain aspects of the present disclosure. As shown, communication exchange 3300 includes a client 252, the client organization 412, the KYC network 2100, a document verification service 2122, and the MDDV 202.

As an initial step, a file or a group of files with new document images are uploaded to the MDDV 202 by the client 252.

At steps 1-4, the client 252 initiates a transaction to create the documentProof asset. This action grants permission to the document verification service 2122 to read files with document images from the MDDV 202.

At steps 5-9, the document verification service 2122 subscribes to the DOCUMENT CREATED event. When the event is received, it reads the file from the MDDV 202 (several times if there is more than one file with document image), parses data from document images, performs validity and AML checks, uploads the file with parsing and checks results to the MDDV 202, adds to the documentProof asset in the KYC network 2100.

At steps 9-11, the document verification service 2122 sends a transaction to the KYC network 2100 containing a hash of the personal data from the newly uploaded document. Smart contract logic cryptographically checks both this hash and hash of the personal data extracted from the previously uploaded document and makes a final decision.

At step 12, the KYC network 2100 generates the KYC_DOCUMENT_PROCESSED event.

At step 13, the client 252 receives a document verification result.

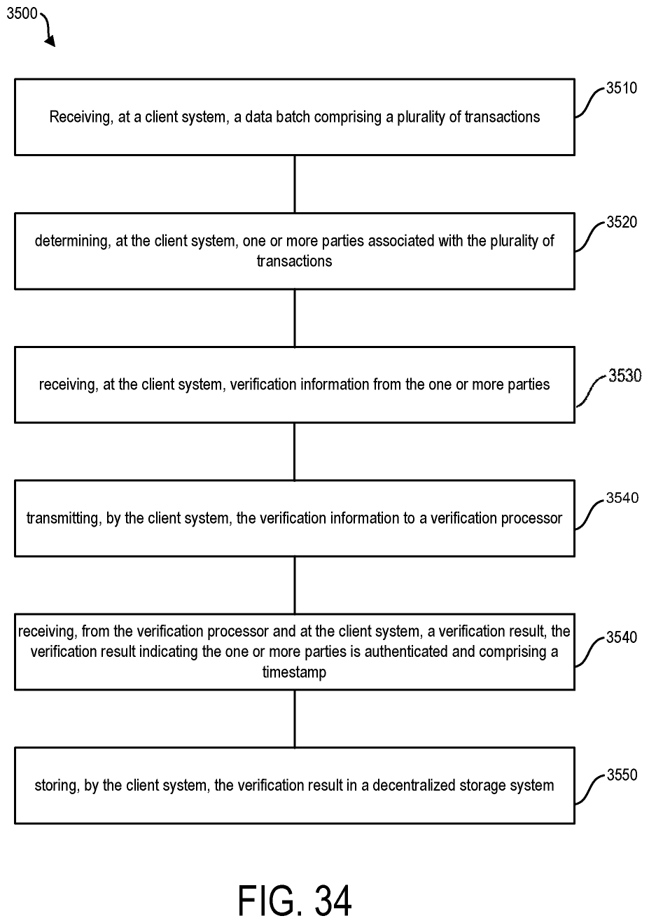

FIG. 34 is a diagram illustrating a method 3500 of verifying a transaction. One or more of the steps described in the method 3500 of FIG. 35 may be performed by a client system 252, the data splitter 205, the DVS 402, a server, or any other similar device.

At block 3510, the method includes receiving, at a client system, a data batch comprising a plurality of transactions. At block 3520, the method includes determining, at the client system, one or more parties associated with the plurality of transactions. At block 3530, the method includes receiving, at the client system, verification information from the one or more parties.

At block 3540, the method includes transmitting, by the client system, the verification information to a verification processor. At block 3540, the method includes receiving, from the verification processor and at the client system, a verification result, the verification result indicating the one or more parties is authenticated and comprising a timestamp At block 3550, the method includes storing, by the client system, the verification result in a decentralized storage system.

In some aspects, the decentralized storage system may be configured to split, based on a sensitivity level of the verification information, the verification information received at the client computer system into smaller data portions. The decentralized storage system may further be configured to store pointers to the data portions of the verification result in separate private blockchain networks, each of the separate private blockchain networks having different encryption mechanisms.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments, one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A method of verifying a transaction, the method comprising:
receiving, at a client system, a data batch comprising a plurality of transactions;
determining, at the client system, one or more parties associated with the plurality of transactions;
receiving, at the client system, verification information from the one or more parties;
transmitting, by the client system, the verification information to a verification processor;
receiving, from the verification processor and at the client system, a verification result, the verification result indicating the one or more parties is authenticated and comprising a timestamp; and
storing the verification result in a decentralized storage system comprising a plurality of private blockchain networks, the decentralized storage system configured to:
split, based on a sensitivity level of the verification information, the verification information received at the client computer system into smaller data portions; and
store pointers to the data portions of the verification result in separate private blockchain networks.

2. A system for providing a cryptographic platform for exchanging information, the system comprising:
a client computer system, the client computer system comprising a data splitter configured to split, based on a sensitivity level of data, data received at the client computer system into smaller data portions;
a multi-decentralized data vault (MDDV) configured to store sensitive data;
a decentralized storage system comprising a plurality of private blockchains, the decentralized storage system configured to store the data portions in separate locations.

3. The system of claim 2, wherein the data comprises passport, licenses, and/or legal information.

4. The method of claim 1, wherein the data stored in the decentralized data storage comprises at least one of personal data, keys to digital wallets, know your customer data, document, biometric data, and audio or video files.

5. The method of claim 4, wherein the biometric data is selected from fingerprints, DNA information for humans or animals, voice data, and dynamic facial movement data.

6. The method of claim 1, the client system further comprising:
a data builder configured to:
retrieve, from the multi-decentralized private block chains network, the pointers to the data portions;
request, from the decentralized storage system and based on the pointers, the data portion action stored within the separate private block chains;
receive, from the decentralized storage system in response to the request, the data portions; and
construct the data from the received data portions.

7. The system of claim 2, wherein the MDDV comprises a first layer of networks that are configured to define conditions to retrieve data in the MDDV.

8. The system of claim 7, wherein the first layer of networks share at least one peer with the decentralized storage system.

9. The method of claim 1, wherein splitting the verification information includes:
generating encryption keys for the verification information;
transforming the verification information using a first encryption key, the verification information transformed into first data;
encrypting the first data using a second encryption key to obtain second data; and
splitting the second data into a first quantity of first data chunks.

10. The method of claim 9, wherein splitting the verification information further includes:
sharing the second encryption key;
generating, based on the second encryption key, a second quantity of second data chunks; appending the second data chunks to the first data chunks; and
hashing the appended data chunks.

11. The method of claim 1, further comprising:
responsive to splitting the verification information, collecting data chunks to reassemble;
validating, responsive to the collecting, data integrity for each chunk;
determining, responsive to the validating, whether a quantity of valid chunks satisfies a threshold;
obtaining the threshold quantity of validated data chunks;
recovering a first encryption key;
recovering, based on the first encryption key, first encrypted data chunks;
decrypting the first encrypted data chunks to obtain second encrypted data chunks and a second encryption key; and
decrypting, using the second encryption key, the second encrypted data chunks to obtain original verification information.

12. A system, comprising:
at least one data processor; and
at least one memory storing instructions which, when executed by the at least one data processor, result in operations comprising:
receiving, at a client system, a data batch comprising a plurality of transactions;
determining, at the client system, one or more parties associated with the plurality of transactions;
receiving, at the client system, verification information from the one or more parties;
transmitting, by the client system, the verification information to a verification processor;
receiving, from the verification processor and at the client system, a verification result, the verification result indicating the one or more parties is authenticated and comprising a timestamp; and
storing the verification result in a decentralized storage system comprising a plurality of private blockchain networks, the decentralized storage system configured to:
split, based on a sensitivity level of the verification information, the verification information received at the client computer system into smaller data portions; and
store pointers to the data portions of the verification result in separate private blockchain network.

13. The system of claim 12, wherein the data batch comprises passport, licenses, and/or legal information.

14. The system of claim 12, wherein the verification result stored in the decentralized data storage comprises at least one of personal data, keys to digital wallets, know your customer data, document, biometric data, and audio or video files.

15. The system of claim 14, wherein the biometric data is selected from fingerprints, DNA information for humans or animals, voice data, and dynamic facial movement data.

16. The system of claim 14, wherein splitting the verification information includes:
generating encryption keys for the verification information;
transforming the verification information using a first encryption key, the verification information transformed into first data;
encrypting the first data using a second encryption key to obtain second data; and
splitting the second data into a first quantity of first data chunks.

17. The system of claim 16, wherein splitting the verification information further includes:
sharing the second encryption key;
generating, based on the second encryption key, a second quantity of second data chunks;
appending the second data chunks to the first data chunks; and
hashing the appended data chunks.

18. The system of claim 12, wherein the operations further comprising:
responsive to splitting the verification information, collecting data chunks to reassemble;
validating, responsive to the collecting, data integrity for each chunk;
determining, responsive to the validating, whether a quantity of valid chunks satisfies a threshold;
obtaining the threshold quantity of validated data chunks;
recovering a first encryption key;
recovering, based on the first encryption key, first encrypted data chunks;
decrypting the first encrypted data chunks to obtain second encrypted data chunks and a second encryption key; and
decrypting, using the second encryption key, the second encrypted data chunks to obtain original verification information.

19. The system of claim 12, wherein splitting the second data into a first quantity of first data chunks includes splitting the second data using a Bose—Chaudhuri— Hocquenghem (BCH) code.

20. A non-transitory computer readable medium storing instructions which, when executed by at least one processor, cause operations comprising:
receiving, at a client system, a data batch comprising a plurality of transactions;
determining, at the client system, one or more parties associated with the plurality of transactions;
receiving, at the client system, verification information from the one or more parties;
transmitting, by the client system, the verification information to a verification processor;
receiving, from the verification processor and at the client system, a verification result, the verification result indicating the one or more parties is authenticated and comprising a timestamp; and
storing the verification result in a decentralized storage system comprising a plurality of private blockchain networks, the decentralized storage system configured to:
split, based on a sensitivity level of the verification information, the verification information received at the client computer system into smaller data portions; and
store pointers to the data portions of the verification result in separate private blockchain network.
